(19) United States
(12) Patent Application Publication
(10) Pub. No.: US 2022/0228054 A1
(43) Pub. Date: Jul. 21, 2022

(54) FLUORESCENT NAPHTHALIMIDE POLYMERS AND SOLUTIONS THEREOF FOR SCALE CONTROL IN AQUEOUS SYSTEMS

(71) Applicant: NOURYON CHEMICALS INTERNATIONAL B.V., Arnhem (NL)

(72) Inventors: Klin Aloysius RODRIGUES, Arnhem (NL); Jannifer SANDERS, Arnhem (NL); Keitaro SETO, Arnhem (NL); Jobie Lebron JONES, Arnhem (IL)

(73) Assignee: NOURYON CHEMICALS INTERNATIONAL B.V., Arnhem (NL)

(21) Appl. No.: 17/614,091

(22) PCT Filed: May 27, 2020
(86) PCT No.: PCT/US2020/034690

§ 371 Date: Nov. 24, 2021

Related U.S. Application Data
(60) Provisional application No. 62/853,620, filed on May 28, 2019.

(30) Foreign Application Priority Data
Aug. 30, 2019 (EP) 19194578.1

(51) Int. Cl. C09K 11/02; C09K 11/06; G01N 21/64; C02F 5/12

(52) U.S. Cl. CPC C09K 11/025; C09K 11/06; C02F 2303/14; C02F 5/12; C09K 2211/1466; G01N 21/6447

(57) ABSTRACT

Disclosed are fluorescent water-soluble water treatment polymers suitable for use in scale inhibition in industrial water systems, the water treatment polymers comprising non-quaternized fluorescent naphthalimide derivative monomers. Also disclosed are methods of making the monomers, methods of making the polymers, methods of inhibiting scale in an industrial water system, and methods of using the polymers in coagulation and flocculation, and in cleaning applications.

### PRIORITY CLAIM

This application claims priority of U.S. Provisional Application Ser. No. 62/853,620, filed May 28, 2019, and European Patent Application No. 19194578.1, filed Aug. 30, 2019, the entire contents of which are hereby incorporated by herein by reference.

### FIELD OF THE DISCLOSURE

This application relates to methods of making water-soluble fluorescent water treatment polymers comprising low water-soluble fluorescent naphthalimide monomers, to the fluorescent water treatment polymers obtainable by such methods, and aqueous solutions containing them and their application in a method for controlling scale in industrial water systems by treatment with a water-soluble fluorescent water treatment polymer containing a fluorescent naphthalimide monomer having low water solubility, and their use as an additive to prevent coagulation, to prevent flocculation, or in cleaning applications. This application further relates to fluorescent naphthalimide monomers having low water solubility that are suitable as starting compounds or intermediates in the method of making water-soluble fluorescent water treatment polymers, and to compositions comprising such monomers, that are suitable as premixes to be employed in the method of making water-soluble fluorescent water treatment polymers.

### BACKGROUND

There are many industrial water systems, including, but not limited to, cooling water systems and boiler water systems. Such industrial water systems are subject to corrosion and the formation of scale.

It is known that certain types of water-soluble treatment polymers are effective for inhibiting scale and suppressing the occurrence of corrosion in industrial water systems. These water-soluble treatment polymers are known to persons of ordinary skill in the art of industrial water systems and are widely used in scale inhibition products. Such water-soluble treatment polymers generally exhibit activity against scale when added to water in an amount in the range of from about 1 to about 100 ppm.

The efficacy of water-soluble treatment polymers in inhibiting scale and suppressing corrosion depends in part on the concentration of the water-soluble treatment polymer in the water system. Water-soluble treatment polymers added to an industrial water system can be consumed by many causes, leading to changes in concentration of the water-soluble treatment polymer. Therefore, it is important for the optimum operation of an industrial water system to be able to accurately determine the concentration of water-soluble treatment polymers in the water.

It is known that the concentration of water-soluble treatment polymers used as components of scale and corrosion inhibitors in industrial water systems can be monitored if the polymer is tagged with a fluorescent monomer. The amount of fluorescent monomer incorporated into the water-soluble polymer must be enough so that the fluorescence of the water-soluble polymer can be adequately measured, however, it must not be so much as to adversely impact the performance of the water-soluble polymer as a treatment agent. Because the concentration of the tagged water-soluble treatment polymer can be determined using a fluorimeter, it is also possible to measure consumption of the water-soluble treatment polymer directly. It is important to be able to measure consumption directly because consumption of a water-soluble treatment polymer usually indicates that a non-desired event, such as scaling, is occurring. Thus, by being able to measure consumption of the water-soluble treatment polymer, there can be achieved an in-line, real time in situ measurement of scaling activity in the industrial water system. Such in-line, real time measurement systems are disclosed, for example, in U.S. Pat. Nos. 5,171,450, 5,986,030, and 6,280,635, all of which are incorporated herein by reference.

A wide array of water treatment formulations will also contain phosphate to minimize corrosion. Many states now have regulations limiting the amount of phosphates that can be used in water treatment systems or otherwise be potentially released to the environment. Even in states where the use of phosphate is allowed, it is considered desirable to minimize the amount of phosphate released to the environment. Therefore, the use of higher pH water systems that are lower in phosphates is becoming more common. But such higher pH water systems lead to increased carbonate scaling. Therefore, there is a need for methods of controlling carbonate scale in industrial water systems, particularly in higher pH environments.

It is further known in the art that some water-soluble treatment polymers will be more effective in the inhibition of phosphate scale, while other water-soluble treatment polymers will be more effective in the inhibition of carbonate scale. Yet others will be more effective in the inhibition of silica and silicates scales, and still others will be effective in the inhibition of sulfate scale.

Naphthalimide and certain naphthalimide derivatives are known fluorescent compounds that can be converted to polymerizable fluorescent monomers for use in such systems. Naphthalimide has the structural formula:

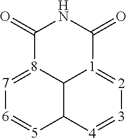

wherein the benzene carbon atoms for purposes of illustrating the present disclosure. The present disclosure uses “ortho” to refer alternatively to the 2- or 7-positions; “meta” to refer alternatively to the 3- or 6-positions; and “para” to refer alternatively to the “4” or “5” positions.

Because water-soluble treatment polymers are typically polymerized in an aqueous medium, it has been known to use water-soluble naphthalimide derivative monomers in the manufacture of such water treatment polymers, as shown, for example, in U.S. Pat. No. 6,645,428, which discloses water-soluble quaternized naphthalimide derivative monomers and the use thereof to prevent or reduce phosphate scale. The process described in US '428 has as an additional major disadvantage that we've discovered—the monomers are not completely reacted into the polymer and stay in the product. As the monomers also contain the fluorescent napthalimide unit, this makes the fluorescent signal unreliable when used in water treatment.

Certain other non-quaternized naphthalimide derivative monomers such as for example disclosed in RU2640339 also have fluorescent signals, but have at best low solubility in water, which makes it difficult to form water-soluble fluorescent water treatment polymers using these monomers, and aqueous compositions of such monomers.

Non-quaternized fluorescent napthalimide polymers are desirable in water treatment systems as they are compatible and thereby well combinable in one composition with the often used chlorine based biocides, while quaternized polymers would react with such chlorine based biocides and thereby possibly destroy the fluorescent signal and may not be able to maintain free chlorine.

It thus would be desirable to provide compositions and methods for controlling scale, mainly carbonate scale and phosphate scale, in industrial water systems comprising treating with a water-soluble fluorescent water treatment polymer containing a non-quaternized fluorescent naphthalimide monomer which polymer provides a reliable detectable fluorescent signal under typical industrial water treatment conditions, and methods of making such polymers.

It further would be desirable to provide low water-soluble naphthalimide monomers, to provide a process to employ them and convert them into such water-soluble water treatment polymers, and methods of making such monomers.

### SUMMARY

In one aspect, the present disclosure relates to water-soluble fluorescent polymer useful in water treatment and obtainable by polymerizing a polymerization mixture comprising:
(a) at least one carboxylic acid monomer present in an amount of 10-99.999 mol % based on 100 mol % of the polymer; and
(b) at least one non-quaternized fluorescent naphthalimide derivative monomer selected from Structure (I) and Structure (II):

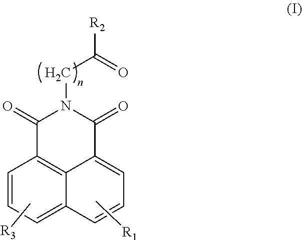

wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably H or C₁-C₂alkyl, more preferably H or C₁alkyl,
n=0-10, and is preferably 1, and
m=1-10;
and

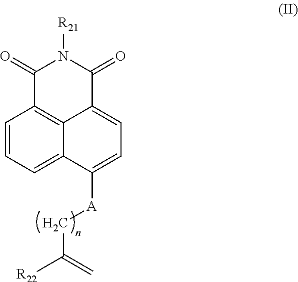

wherein A is selected from —(NR₂₃)—, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-, and
R₂₂ and R₂₄ are independently H or C₁-C₄alkyl, preferably H or C₁-C₂alkyl, more preferably H or C₁alkyl,
   said at least one non-quaternized fluorescent monomer being present in the water-soluble fluorescent polymer in an amount of 0.001-20 mol %.

In one aspect, this disclosure relates to methods of making water-soluble fluorescent water treatment polymers wherein low water-soluble non-quaternized fluorescent naphthalimide derivative monomers are polymerized. In another embodiment of the method, the polymerization reaction takes place in an aqueous reaction medium. In another embodiment of the method, the polymerization reaction takes place in a non-aqueous reaction medium. In yet another aspect, this disclosure relates to aqueous compositions comprising water-soluble fluorescent polymers obtainable by the above method, suitable for use as a water treatment polymer, wherein the polymer comprises a non-quaternized fluorescent naphthalimide derivative monomer. The water-soluble polymer can be present in the aqueous composition as at least 10 wt %.

In one aspect this disclosure relates to a method of treating an industrial water system to aid in inhibiting the deposition of scale, the method comprising treatment of the industrial water system with a water-soluble fluorescent water treatment polymer wherein the polymer comprises a non-quaternized fluorescent naphthalimide derivative monomer.

In one aspect, this disclosure relates to certain novel non-quaternized naphthalimide derivative monomers that are suitable starting materials and intermediates in the above method of making water-soluble fluorescent water treatment polymers.

In one aspect, this disclosure relates to compositions comprising selected non-quaternized fluorescent naphthalimide derivative monomers that are suitable premixes for performing the above method of making water-soluble fluorescent water treatment polymers.

In one aspect, the disclosure relates to an aqueous composition comprising a water-soluble fluorescent water treatment polymer wherein the polymer comprises at least one carboxylic acid monomer and a non-quaternized fluorescent naphthalimide derivative monomer selected from

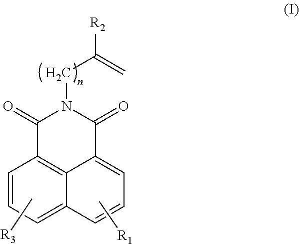

wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably C₁-C₂alkyl, more preferably C₁alkyl,
n=0-10, and is preferably 1, and
m=1-10;
and

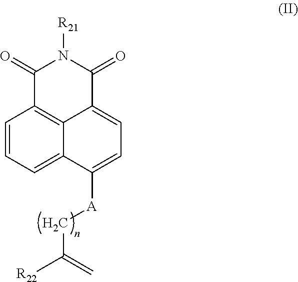

wherein A is selected from —(NR23)-, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-,
R₂₂ and R₂₄ are independently H or alkyl, preferably C₁-C₂alkyl, more preferably C₁alkyl,
   said at least one non-quaternized fluorescent monomer being present in the water treatment polymer in an amount of 0.001-20 mol %. The polymer optionally includes at least one additional comonomer selected from the group consisting of at least one phosphorous moiety, at least one sulfonic acid monomer, and at least one non-ionic monomer, wherein the optional comonomer is present as at least 1 mol % of the polymer. in one preferred embodiment, the non-fluorescent monomers of the polymer are substantially free of amine groups.

It should be noted that in the Structure (I), R₁ and R₃ may have different positions on the aromatic ring, namely para, ortho or meta. In addition, R₁ and R₃ may occupy the same ring. For example, R₁ could be at position 4 and R₃ could be at position 5, i.e., both are para substituents but located on different benzene rings; or R₁ could be at position 4 and R₃ at position 3, i.e., R₁ is para substituted and R₃ is meta substituted but both are located on the same benzene ring.

The other monomers of the fluorescent water treatment polymers as disclosed herein can be selected to provide water treatment polymers that are effective in the inhibition of any one or more of carbonate scale, phosphate scale, silica scale, and sulfate scale, most importantly carbonate scale and phosphate scale.

### DETAILED DESCRIPTION

As used herein, “naphthalimide derivative monomer” means a naphthalimide molecule having an ethylenically unsaturated polymerizable group substituted thereon and optionally having other substituents.

As used herein, the term “dosing” of a reactant into a reaction mixture means that the reactant is added over a period of time during the course of the reaction, as opposed to a single addition of an entire reactant portion. As used herein, the term “dosing” of a reactant into a reaction mixture encompasses addition of a reactant to a reaction mixture as a continuous stream, addition of a reactant into a reaction mixture as several intermittent shots, and combinations thereof.

As used herein, the term “low water-soluble” with respect to fluorescent naphthalimide derivative monomers means that the fluorescent naphthalimide derivative monomer has a water solubility of less than 1 gram per 100 mls of water at 25° C., or less than 0.5 grams per 100 mls of water at 25° C., and or less than 0.1 grams per 100 mls of water at 25° C., or less than 0.01 grams per 100 mls of water at 25° C., all at pH 7.

As used herein, the term “water-soluble” with respect to the fluorescent water treatment polymers disclosed herein means that the fluorescent water treatment polymers have a water solubility of at least 10 grams per 100 mls of water at 25° C., preferably at least 20 grams per 100 mls of water at 25° C., and most preferably at least 30 grams per 100 mls of water at 25° C., all at pH 7.

The water-soluble treatment polymer needs to be pumpable. In a preferred embodiment, the viscosity of the water-soluble treatment polymer needs to be less than 25,000 cps, less than 10,000 cps and preferably less than 5000 cps and most preferably less than 2500 cps at preferably 10, more preferably 20, more preferably 30, most preferably 40% polymer solids at 25° C. at 10 rpm in the pH range 2-10, preferably 3-8 most preferably 4-6.

As used herein, the term “substantially free of amine groups” means the non-quaternized fluorescent naphthalimide derivative monomer has less than 10 mol %, less than 5 mol %, less than 1 mol % or is free of primary, secondary or tertiary amine groups.

Substantially free of impurities in Structure (I) means that the impurity of Structure (III) is preferably less than 20%, preferably less than 15%, preferably less than 10%, more preferably less than 5%, and most preferably less than 2% or is undetectable of Structure (I) when measured by area percent using a suitable analytical technique such as liquid chromatography.

Substantially free of impurities in Structure (II) means that the impurity of Structure (IV) is preferably less than 20%, preferably less than 15%, preferably less than 10%, more preferably less than 5%, and most preferably less than 2% or is undetectable of Structure (IV) when measured by area percent using a suitable analytical technique such as liquid chromatography.

The mol % determination by LC requires that each compound the synthesized and purified to get a viable LC standard. For purposes of this disclosure, the mol % is correlated to the ranges of area % by LC as shown below.

Unless otherwise indicated, that a first substance is “substantially free” of a second substance, as used herein, means, as discussed above, that the first substance has preferably less than 20 mol % (15-25 area % by LC), preferably less than 15 mol % (10-20 area % by LC), preferably less than 10 mol % (5-15 area % by LC), more preferably less than 5 mol % (2.5-7.5 area % by LC), more preferably less than 3 mol % (1-5 area % by LC), more preferably less than 2 mol %(1-3 area % by LC), and most preferably less than 1.5 mol % (1-2 area % by LC) or is even completely free of the second substance relative to 100 mol % of the first substance.

Unless otherwise indicated, all percentages of a composition, for example, a solid or a solution, are mole percentages based on the total composition.

Polymerization Methods

There are 3 main processes (Method A, B and C below) that can preferably be used to prepare a water-soluble fluorescent polymer useful in water treatment. Method A is the one that would be most preferred and would be utilized in most cases.

In these methods, the non-quaternized fluorescent napthalimide derivative monomer is a monomer that has a low water solubility as defined herein, or if more than one of such monomers is used at least one of the non-quaternized fluorescent napthalimide derivative monomers has such low water solubility.

In embodiments of polymerizing the fluorescent water treatment polymers as disclosed herein, it is desirable to maximize the amount of added fluorescent monomer that is polymerized into the polymer. It is preferred that at least 85% of the fluorescent monomer added to the polymerization reaction be converted to the polymer or at least 90%, or at least 92%, or at least 95%, or at least 98%, or at least 99%, or is below the level of detection. It also is desirable to achieve an even distribution of the fluorescent monomer along the polymer backbone. These objectives can be achieved by polymerization methods in which one or more of the monomers or initiators are dosed into the reaction medium at a controlled rate, in accordance with the disclosed embodiments. The choice of polymerization method will depend on the relative solubilities and reactivities of the selected monomers, and the selected solvents.

### Method A—Dosing of Fluorescent Monomer, Acid Monomer, and Initiator

One method for polymerization of a water-soluble fluorescent water treatment polymer comprising one or more non-quaternized fluorescent naphthalimide monomers comprises the steps of
a) providing a quantity of a non-quaternized fluorescent naphthalimide derivative monomer as disclosed herein;
b) dissolving the non-quaternized fluorescent naphthalimide derivative monomer in a quantity of a liquid polymerizable carboxylic acid monomer to provide a fluorescent monomer—acid monomer solution;
c) dosing the fluorescent monomer—acid monomer solution into a reaction medium; optionally adding a part of the fluorescent monomer—acid monomer solution to the initial polymerization solution or a part of the fluorescent monomer to the initial polymerization solution;
d) initiating polymerization of dosed monomers in the reaction medium in the presence of a polymerization initiator, and
e) maintaining the dosing of the fluorescent monomer—acid monomer solution into the reaction medium during the polymerization reaction, such that the polymerization reaction continues while the fluorescent monomer—acid monomer solution is being dosed to the reaction medium,
f) optionally adding other acid monomers and/or other monomers after the end of the fluorescent monomer—acid monomer solution has been dosed to maximize the conversion of the fluorescent monomer.
   wherein the polymerization reaction yields a water-soluble fluorescent polymer suitable for use in treatment of an industrial water system.

Optionally, the fluorescent monomer can be dissolved in a solvent that is preferably water miscible or into other non-carboxylic acid monomers and a part of this can be added to the initial polymerization solution and the other part dosed in to the polymerization process.

In one embodiment the reaction medium is aqueous; optionally including co-solvents which can include without limitation dimethyl formamide, methanol, ethanol, isopropanol, n-propanol, glycols, and glycol ethers. In another embodiment, the reaction medium is non-aqueous, with xylene being a preferred non-aqueous reaction medium. The selection of aqueous or non-aqueous reaction medium could depend on the choice of carboxylic acid monomer used. For example, if the carboxylic acid monomer is acrylic acid or methacrylic acid, then an aqueous reaction medium can be preferred, while if the carboxylic acid is maleic acid, itaconic acid, or either of their anhydrides or salts, then a non-aqueous reaction medium can be preferred. Where a non-aqueous reaction medium is used, as a final step the non-aqueous medium is removed and the reaction product is converted to an aqueous composition. The reaction medium or purification step is preferably free of chlorinated solvents since these are environmentally friendly. The final aqueous solution of the polymer is preferably free of chlorinated solvents. This means that the final aqueous solution of the polymer has less than 1%, less 0.1%, less than 0.01% and most preferably does not have any chlorinated solvents.

This embodiment of the method is useful when the non-fluorescent monomers in the mixture polymerize more rapidly than the fluorescent monomers under the reaction conditions employed. Dosing the more highly reactive monomers into the reaction medium at a controlled rate provides a controlled rate of reaction and more even distribution of the fluorescent monomer along the polymer chain. Otherwise, if the more highly reactive non-fluorescent monomers are fully present at the initiation of the polymerization reaction, then it is possible that the non-fluorescent monomers will react mostly with themselves, with uneven distribution of the fluorescent monomer in the water treatment polymer. It is also possible that relatively large amounts of the fluorescent monomer would remain unpolymerized; such unpolymerized monomers present in a water treatment composition can lead to inaccurate and misleading indications of scale inhibition when such compositions are added to an industrial water system and the resulting fluorescence is measured. Acrylic acid and methacrylic acid both have faster polymerization rates than some of the allylic fluorescent monomers disclosed herein. Therefore, if these monomers are used, then it is preferred to use the method as described above wherein the acid monomer-fluorescent monomer solution is dosed into the reaction medium at a controlled rate.

This method also is advantageous when the fluorescent monomer is a low water-soluble monomer and the reaction medium is aqueous. The low water-soluble monomer can first be dissolved in the liquid carboxylic acid monomer, and the addition rate of the acid-monomer-fluorescent monomer solution can be controlled so that the fluorescent monomer remains dissolved in the aqueous polymerization reaction medium. This can be observed visually during the reaction, wherein a clear solution indicates that the monomers remain dissolved, and a hazy appearance can indicate that any of the monomers is not dissolved.

One or more additional monomers can be present in the polymerization mixture. The one or more additional monomers can be present in the reaction medium when dosing of the fluorescent monomer—acid monomer solution is begun; or the one or more additional monomers can be present in the fluorescent monomer—acid monomer solution that is dosed into the reaction medium; or the one or more additional monomers can be present as an additional monomer solution that is dosed to the reaction medium concurrently with at least part of the dosing of either the fluorescent monomer-acid monomer solution or the initiator solution.

The polymerization reaction can be allowed to continue after dosing of all reactants to the aqueous reaction medium is complete.

As the fluorescent monomer is dosed to the reaction mixture, it is consumed as part of the polymerization reaction and therefore there exists an equilibrium concentration of fluorescent monomer in the reaction mixture. Depending on the solubility of the fluorescent monomer in the reaction medium, the equilibrium concentration of the fluorescent monomer can be less than 1000 ppm, or less than 200 ppm, or less than 100 ppm in the reaction mixture, if the solvent is water.

To optimize the polymerization of the water-soluble fluorescent water polymer, it is preferred that the fluorescent monomer—acid monomer solution be dosed slowly into the reaction medium. Dosing of the fluorescent monomer—acid monomer solution is carried out over a time period of from about five minutes to about 24 hours; or from about 30 minutes to about 18 hours, or from about 1 hour to about ten hours. In one embodiment, the fluorescent monomer—acid monomer solution can be added at a rate of no more than 50% of the total dosage amount per hour, or no more than 40% of the total dosage amount per hour, or no more than 30% of the total dosage amount per hour, or no more than 25% of the total dosage amount per hour, or no more than 20% of the total dosage amount per hour, or no more than 15% of the total dosage amount per hour, or no more than 10% of the total dosage amount per hour.

In one embodiment the polymerization initiator solution is dosed to the reaction medium at a rate no faster than the rate of the dosage of the fluorescent monomer—acid monomer solution, based on the total dosage amount of polymerization initiator.

The skilled artisan will adjust the dosage rates and time of the reaction to achieve optimum polymerization of the water-soluble fluorescent water treatment polymer, based on the disclosure herein, taking into consideration the quantity of reactants, the visual appearance of the reaction mixture and the capacity and features of the reaction vessel and dosing apparatus used for each use of the disclosed method as well as the conversion of the fluorescent monomer to polymer during the polymerization process. For example, if the reaction mixture is cloudy, it indicates that the dosing rate needs to be decreased.

The reaction mixture typically is heated during the step of dosing of the reactants. The heating may be continued during the polymerization reaction until the reaction is substantially complete. In one embodiment the reaction may be terminated by discontinuing the heating of the reaction mixture. In one embodiment, if a co-solvent is used, the reaction may be terminated by distilling the co-solvent. The reaction temperature can be at least 30° C., 50° C., or at least 60° C., or at least 70° C., or at least 80° C. In one embodiment the polymerization reaction mixture is heated to its reflux temperature. In one embodiment the reaction temperature is in the range of 90−95° C.

### Method B—Dosing of Initiator

In some water treatment polymers, the non-fluorescent monomers may have polymerization reactivities more similar to those of the selected fluorescent monomers. For example itaconic acid and maleic acid both have slower polymerization rates than acrylic acid and methacrylic acid. When itaconic acid or maleic acid or their salts or anhydrides are used as all or part of the carboxylic acid monomer, then it is possible to have either the carboxylic acid monomer or the fluorescent monomer, or both, present in their full amounts in the reaction medium at initiation of the polymerization reaction. The reaction rate is then controlled by the rate of dosing of the initiator to the reaction medium.

This method for polymerization of a water-soluble fluorescent water treatment polymer comprising one or more non-quaternized fluorescent naphthalimide derivative monomers comprises the steps of
a) providing a quantity of a non-quaternized fluorescent naphthalimide derivative monomer,
b) adding the full amount of the non-quaternized fluorescent naphthalimide derivative monomer and the carboxylic acid monomer into a reaction medium,
c) providing an initiator solution,
d) dosing said initiator solution to said reaction medium to initiate the polymerization reaction, and
e) maintaining the dosing of the initiator solution into the reaction medium during the polymerization reaction, such that the polymerization reaction continues while the initiator solution is being dosed to the reaction medium, wherein the polymerization reaction yields a water-soluble fluorescent polymer suitable for use in treatment of an industrial water system.

The fluorescent monomer can be added to the reaction medium as a solid and dissolved in the reaction medium, or the fluorescent monomer can first be dissolved in an appropriate solvent and then added to the reaction medium.

### Method C—Dosing of Initiator and Fluorescent Monomer

In another embodiment, the polymerization comprises the steps of
a) dissolving a carboxylic acid monomer in a reaction medium,
b) providing a quantity of a non-quaternized fluorescent naphthalimide derivative monomer,
c) providing an initiator solution,
d) dosing said initiator solution to the reaction medium, and
e) dosing the fluorescent monomer to the reaction medium during the dosing of the initiator solution,
   wherein the polymerization reaction yields a water-soluble fluorescent polymer suitable for use in treatment of an industrial water system.

In this method, the reaction medium can be aqueous or non-aqueous. The fluorescent monomer can be added in the form of a solution or a solid. This polymerization method is useful when the carboxylic acid monomer is a relatively slow-reacting monomer, such as itaconic acid, maleic acid, or their anhydrides or salts.

In any of the foregoing polymerization methods, the product is an aqueous composition of the water-soluble fluorescent water treatment. In one embodiment the reaction product is an aqueous solution of the water-soluble treatment polymer in which the polymer is present as at least 10 wt %, in one embodiment at least 20 wt %, in one embodiment at least 30 wt %, in one embodiment at least 40 wt %. As an optional additional step the polymerization reaction product can be dried to a powder or granule.

In any of the foregoing polymerization methods, the polymerization initiators are any initiator or initiating system capable of liberating free radicals under the reaction conditions employed. The free radical initiators are present in an amount ranging from about 0.01% to about 3% by weight based on total monomer weight. In an embodiment, the initiating system is soluble in water to at least 0.1 weight percent at 25° C. Suitable initiators include, but are not limited to, peroxides, azo initiators as well as redox systems, such as erythorbic acid, and metal ion based initiating systems. Initiators may also include both inorganic and organic peroxides, such as hydrogen peroxide, benzoyl peroxide, acetyl peroxide, and lauryl peroxide; organic hydroperoxides, such as cumene hydroperoxide and t-butyl hydroperoxide. In an embodiment, the inorganic peroxides, such as sodium persulfate, potassium persulfate and ammonium persulfate, are preferred. In another embodiment, the initiators comprise metal ion based initiating systems including Fe and hydrogen peroxide, as well as Fe in combination with other peroxides. Organic peracids such as peracetic acid can be used. Peroxides and peracids can optionally be activated with reducing agents, such as sodium bisulfite, sodium formaldehyde, or ascorbic acid, transition metals, hydrazine, and the like. A preferred system is persulfate alone such as sodium or ammonium persulfate or a redox system with iron and persulfate with hydrogen peroxide. Azo initiators, especially water-soluble azo initiators, may also be used. Water-soluble azo initiators include, but are not limited to, 2,2′-Azobis[2-(2-imidazolin-2-yl)propane]dihydrochloride, 2,2′-Azobis[2-(2-imidazolin-2-yl)propane]disulfate dihydrate, 2,2′-Azobis(2-methylpropionamidine)dihydrochloride, 2,2′-Azobis[N-(2-carboxyethyl)-2-methylpropionamidine]hydrate, 2,2′-Azobis{2-[1-(2-hydroxyethyl)-2-imidazolin-2-yl]propane}dihydrochloride, 2,2′-Azobis[2-(2-imidazolin-2-yl)propane], 2,2′-Azobis(1-imino-1-pyrrolidino-2-ethylpropane)dihydrochloride, 2,2′-Azobis{2-methyl-N-[1,1-bis(hydroxymethyl)-2-hydroxyethl]propionamide}, 2,2′-Azobis[2-methyl-N-(2-hydroxyethyl)propionamide] and others.

The molecular weight of the polymers may be controlled by various compounds used in the art including for example chain transfer agents such as mercaptans, ferric and cupric salts, bisulfites, and lower secondary alcohols, preferably isopropanol. The preferred weight average molecular weight is less than 50000, preferably less than 30000 and most preferably less than 20000. The preferred average molecular weight is greater than 1000, more preferably greater than 2000 and most preferably greater than 3000.

In one embodiment the resulting polymer solution can be neutralized to a desired pH with an appropriate base. The neutralization can occur before, during or after polymerization or a combination thereof. One skilled in the art will recognize that the dicarboxylic acid monomers are typically partially or completely neutralized before or during polymerization to increase reactivity of the monomers and improve their incorporation into the polymer. The polymers may be supplied as the acid or partially neutralized. This allows the water treatment formulator to formulate these polymers in low pH acidic formulations and high pH alkaline formulations.

Suitable neutralization agents include but are not limited to alkali or alkaline earth metal hydroxides, ammonia or amines. Neutralization agents can be sodium, potassium or ammonium hydroxides or mixtures thereof. Amines include but are not limited to ethanol amine, diethanolamine, triethanolamine and others.

While ammonia or amines can be utilized, in one embodiment the polymer is substantially free of ammonium or amine salts. Substantially free of ammonium or amine salts means that the acid groups in the polymer are neutralized with less than 10 mole percent ammonia or amine neutralizing agents, preferably less than 5 mole percent ammonia or amine neutralizing agents, more preferably less than 2 mole percent ammonia or amine neutralizing agents, and most preferably none at all. In another embodiment, ammonium or amine containing initiators, such as ammonium persulfate, or chain transfer systems are not utilized. Surprisingly, it has been found that the presence of ammonium or amine salts has a reduces the hypochlorite bleach stability of the polymer. The polymer is stable to hypochlorite bleach. In one embodiment, the polymer maintains hypochlorite bleach at pH 9 where more than half of the initial free chlorine is maintained after 1 hour at pH 9 at 25° C. in the presence of 10 ppm of active polymer.

Special Considerations

In monomers of Structure (I), when R₁ is alkoxy, such as in the monomer N-allyl-4-methoxy-1,8-naphthalimide, the water solubility of the fluorescent monomer is extremely low. This problem can be overcome by dissolving the non-ionic fluorescent monomer in the acrylic acid and then slowly feeding this solution to the polymerization reaction. The slow addition rate is important to keep the concentration of the N-allyl-4-methoxy-1,8-naphthalimide monomer low enough to have solubility in the reaction mixture as exemplified in the examples below.

As the monomer is added, it is also consumed by the polymerization reaction, so that there exists an equilibrium concentration of monomer in the reaction mixture. For alkoxy fluorescent monomers, this equilibrium concentration should be below about 1500 ppm. At concentrations above about 1500 ppm, the monomer is not soluble in the mixture of acrylic acid and water, even though it is soluble in acrylic acid. Therefore, the equilibrium concentration of the monomer of Structure (I) when R₁ is alkoxy needs to be less than 1500 ppm, preferably less than 1000 ppm, more preferably less than 200 ppm, and most preferably less than 100 ppm in the reaction mixture, particularly if the solvent is water. It is important to recognize that if the reaction mixture becomes too cloudy, the feed rate of the monomer addition is too fast and needs to be decreased. In this manner, the fluorescent monomer is evenly incorporated into the polymer resulting in a water-soluble and useful material.

The polymer having the insoluble monomer polymerized therein is itself water-soluble. These water-soluble polymers are typically sold as a solution in water. In a preferred embodiment, these solutions of the water-soluble polymers that contain (meth) acrylic acid have greater than 10% solids, more preferably greater than 20% solids, and most preferably greater than 30% solids.

In addition, any residual unreacted fluorescent monomer present in the polymer solution will give a fluorescent signal. Therefore, it is desirable to optimize the polymerization of fluorescent monomer in the polymerization reaction mixture. Preferably, the polymerization of the fluorescent monomer is 85-90% or greater. Alternatively, the residual fluorescent monomer is preferably less than 10-15% of the total monomer in the polymer solution.

Water Treatment Polymers

Disclosed herein is a water-soluble fluorescent water treatment polymer made from a polymerization mixture comprising (i) one or more water-soluble carboxylic acid monomers or their salts or anhydrides, (ii) one or more non-quaternized fluorescent monomers, and optionally further comprising any one or more of (iii) phosphorous-containing moieties selected from the group consisting of phosphino group donating moieties and phosphonate group donating moieties, (iv) sulfonic acid monomers and (v) nonionic monomers.

Carboxylic Acid Monomers

Carboxylic acid monomers suitable for the water treatment polymers as disclosed herein include but are not limited to one or more of acrylic acid, methacrylic acid, maleic acid which can be derived from maleic anhydride, itaconic acid, citraconic acid, mesaconic acid, glutaconic acid, aconitic acid, ethacrylic acid, alpha-chloro-acrylic acid, alpha-cyano acrylic acid, alpha-chloro-methacrylic acid, alpha-cyano methacrylic acid, beta methyl-acrylic acid (crotonic acid), beta-acryloxy propionic acid, sorbic acid, alpha-chloro sorbic acid, angelic acid, tiglic acid, p-chloro cinnamic acid, any of their salts and anhydrides, and mixtures of any of the foregoing. In one embodiment the additional carboxylic acid monomers can include mono-alkylesters of dicarboxylic acids including maleic acid and fumaric acid, such as monomethyl maleate and monoethyl maleate.

In one embodiment, the carboxylic acid monomers include those which can dissolve the low water-soluble fluorescent naphthalimide derivative monomer, at any temperature from ambient up to the temperature at which the fluorescent monomer—acid monomer solution is dosed to the aqueous reaction medium, optionally in the presence of a co-solvent. Preferred carboxylic acid monomers for this purpose include acrylic acid and methacrylic acid, and combinations thereof, with acrylic acid being preferred.

Carboxylic acid monomers which are solid, such as maleic acid and itaconic acid, also can be used.

In one embodiment, the carboxylic acid monomers are water-soluble. As used herein with respect to water-soluble carboxylic acid monomers, water-soluble means that the monomer has a water solubility as the acid of greater than 1 gram per 100 mls of water at 25° C., preferably greater than 5 grams per 100 mls of water at 25° C., and most preferably greater than 10 grams per 100 mls of water at 25° C.

The total carboxylic acid monomers, including acrylic acid, methacrylic acid, maleic acid, itaconic acid and any additional carboxylic acid monomers, will be present in the polymerization mixture in the range of 10-99.9 mol %.

Non-Quaternized Fluorescent Naphthalimide Derivative Monomers

The fluorescent monomers are non-quaternized naphthalimide derivatives represented by the structures (I) and (II):

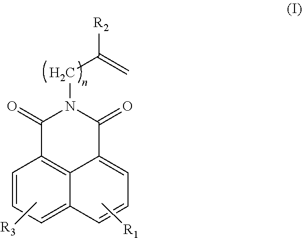

where R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably C₁-C₂alkyl, more preferably C₁alkyl,
n=0-10, and is preferably 1, and
m=1-10;
and

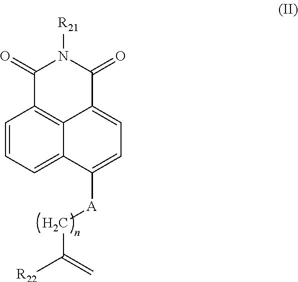

wherein A is selected from —(NR23)-, or —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-, and
R₂₂ and R₂₄ are independently H or C₁-C₄alkyl, preferably C₁-C₂alkyl, more preferably C₁alkyl.

In one embodiment of Structure (I), R₁ is selected from alkoxy, preferably selected from methoxy, ethoxy, propyloxy, isopropyloxy, n-butoxy, iso-butoxy, and tert-butoxy; more preferably methoxy, ethoxy, or propyloxy. In one embodiment of Structure (I), if n=1, R₂ is H, and R₃ is H, then R₁ is not OCH₃.

As used herein, unless otherwise indicated, “alkyl” groups, whether alone or a part of other groups, for example, “alkoxy” or “alkylene,” have any suitable carbon atom range, but preferably have 1-10 carbon atoms, most preferably 1-6 carbon atoms, and are optionally substituted by suitable substituents.

As used herein, unless otherwise indicated, “aryl” groups, whether alone or a part of other groups, for example, “aryloxy” or “arylalkoxy,” have any suitable carbon atom range, but preferably have 6-14 carbon atoms, most preferably 6 or 10 carbon atoms, i.e., phenyl or naphthyl, and are optionally substituted by suitable substituents.

As used herein, unless otherwise indicated, “heteroaryl” groups, whether alone or a part of other groups, have any suitable combination of heteroatoms and carbon atoms, but preferably have 3-10 ring carbon atoms and 1-3 ring heteroatoms independently selected from the group consisting of N, O, and S atoms, most preferably 3-5 ring carbon atoms and 1-2 ring heteroatoms independently selected from the group consisting of N, O, and S atoms, and are optionally substituted by suitable substituents.

As used herein, unless otherwise indicated, “suitable substituents” include, but are not limited to, halogen, such as F, Cl, Br or I; NO₂; CN; haloalkyl, typically CF₃; OH; amino; SH; —CHO; —CO₂H; oxo (═O); —C(═O)amino; NRC(═O)R; aliphatic, typically alkyl, particularly methyl; heteroaliphatic; —OR, typically methoxy; —SR; —S(═O)R; —SO₂R; aryl; or heteroaryl; where each R independently is aliphatic, typically alkyl, aryl, or heteroaliphatic. In certain aspects the optional substituents may themselves be further substituted with one or more unsubstituted substituents selected from the above list. Exemplary optional substituents include, but are not limited to: —OH, oxo (═O), —Cl, —F, Br, C₁₋₄alkyl, phenyl, benzyl, —NH₂, —NH(C₁₋₄alkyl), —N(C₁₋₄alkyl)₂, —NO₂, —S(C₁₋₄alkyl), —SO₂(C₁₋₄alkyl), —CO₂(C₁₋₄alkyl), and —O(C₁₋₄alkyl).

In one embodiment, the fluorescent monomer is Structure (I) wherein
R₁ and R₃ are independently selected from H, hydroxy, alkoxy, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof;
R₂ and R₄ are each H,
n=1-10 and is preferably 1, and
m=1-10.

In one embodiment, the fluorescent monomer is Structure (I) wherein
R₁ and R₃ are independently selected from H, C₁-C₄alk-O—(CHR₄CH₂O—)ₘ and heteroaryl which is selected from substituted or unsubstituted pyrrolyl,
R₂ and R₄ are each H,
n=1-10 and is preferably 1, and
m=1-10 and is preferably 1-5.

In one embodiment, the fluorescent monomer is Structure (II) wherein A is —O— or —O-alk-aryl-.

In one embodiment, the fluorescent monomer is Structure (II) wherein
A is —O—,
R₂₁ is selected from H, hydroxy, alkoxy, alkyl, aryl, C₁-C₄alk-O—(CHR₂₄CH₂O—)ₘ, pyrrolyl, N,N-dialkylaminoalkyl, —COOH and its salts, sulfonic acid and its salts, and phosphonic acid and its salts,
m=1-5,
n=1, and
R₂₂ and R₂₄ are independently H or methyl.

In one embodiment, the fluorescent monomer is Structure (II) wherein
A is —O—,
R₂₁ is selected from H, hydroxy, alkoxy, methyl, ethyl, propyl, C₁-C₄alk-O—(CHR₂₄CH₂O—)ₘ, N,N-dialkylaminoalkyl, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-5,
n=1, and
R₂₂ or R₂₄ are independently H or methyl.

Preferred fluorescent naphthalimide monomers for use in the method disclosed herein include
N-allyl-naphthalimide;
N-allyl-4-methoxy-1,8-naphthalimide;
N-allyl-4-propoxy-1,8-naphthalimide;
N-propyl-4-allyloxy-1,8-naphthalimide;
N-allyl-4-(methoxy, triethylene glycol) 1,8-naphthalimide;
N-allyl-4-butylamino-1,8-naphthalimide;
N-(3-dimethylaminopropyl)-4-allyloxy-1,8-naphthalimide; and
N-allyl-3-Nitro-1,8-naphthalimide.

In an embodiment, the non-ionic naphthalimide fluorescent monomer composition used to synthesize the water-soluble polymer is substantially free of impurities of Structure (la) below:

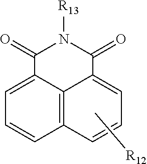

where R₁₂ is halogen, such as chloro, bromo, and iodo etc and R₁₃ is allyl, or where R₁₂ is alkoxy, such as methoxy or methoxy and R₁₃ is H. (R₁₂ in this case can be located on any of the carbon atoms of either benzene group.)

The impurities of Structure (la) are non-monomeric and can give a false signal in the resulting water-soluble polymer formulation when used in an industrial water system. Substantially free of impurities in Structure (I) means that the impurity of Structure (la) is preferably less than 10%, more preferably less than 5%, and most preferably has less than 2% of Structure (I) when measured by area percent using a suitable analytical technique such as liquid chromatography.

In one aspect the non-quaternized fluorescent monomers can be soluble in the carboxylic acid monomer, preferably acrylic acid or methacrylic acid, so that they can be slowly dosed with these monomers during the polymerization process. Alternatively, these non-quaternized fluorescent naphthalimide monomers can be soluble in a mixture of water and alcohol such as isopropyl alcohol or water and water miscible co-solvent at the reaction temperatures of the polymerization process. This ensures uniform distribution of these monomers in the polymer, and also to minimize the residual amount of unreacted monomer in the polymer.

In one aspect, the non-quaternized fluorescent monomers are soluble in acrylic acid, methacrylic acid, or a mixture thereof, such that a composition of the fluorescent monomers comprises
(a) at least one non-quaternized fluorescent monomer selected from

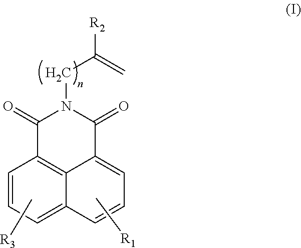

wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably C₁-C₂alkyl, more preferably C₁alkyl,
n=0-10, and is preferably 1, and
m=1-10;
and

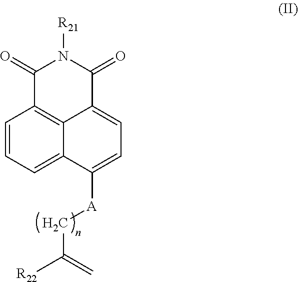

wherein A is selected from —(NR23)-, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-
R₂₂ and R₂₄ are independently H or C₁-C₄alkyl, preferably C₁-C₂alkyl, more preferably C₁alkyl; and
(b) a solvent comprising, acrylic acid, methacrylic acid, or a mixture thereof,
wherein said composition comprises at least 2 wt % of said one or more fluorescent monomers.

In one aspect the composition comprises at least 5 wt % of said one or more fluorescent monomers; in one aspect at least 10 wt % of said one or more fluorescent monomers.

Unreacted fluorescent monomer present in the polymer formulation added to an industrial water system can result in an inaccurate measurement of the polymer in the aqueous system. In one aspect, the residual amount of unreacted fluorescent monomer in the polymerization reaction product is less than 15 mole percent of the fluorescent monomer added to the polymer, preferably less than 10 mole percent of the fluorescent monomer added to the polymer, preferably less than 5 mole percent of the fluorescent monomer added to the polymer, preferably less than 2.5 mole percent of the fluorescent monomer added to the polymer, and most preferably less than 1 mole percent of the fluorescent monomer added to the polymer.

In a preferred embodiment, the fluorescent monomer comprises either (a) Structure (I) comprising less than 20 mol %, based on 100 mol % of Structure (I), of Structure (III) or (b) Structure (II) comprising less than 20 mol %, based on 100 mol % of Structure (II), of Structure (IV), wherein:
Structure (I) is:

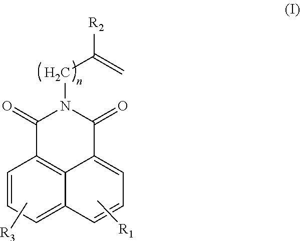

wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably H or C₁-C₂alkyl, more preferably H or C₁alkyl,
n=0-10, and is preferably 1, and
m=1-10;
Structure (II) is:

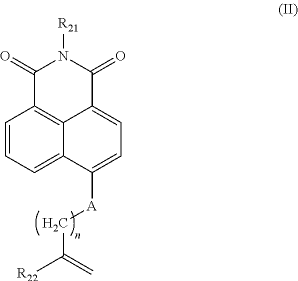

wherein A is selected from —(NR₂₃)—, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-, and
R₂₂ and R₂₄ are independently H or C₁-C₄alkyl, preferably H or C₁-C₂alkyl, more preferably H or C₁alkyl;
Structure (III) is:

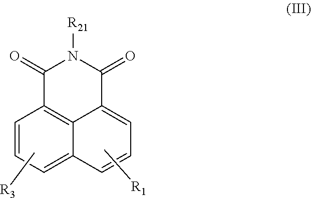

where R₅₅ is H or alkyl; and
Structure (IV) is:

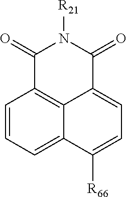

where R₆₆ is H or alkyl.

In an especially preferred embodiment, Structure (I) has less than 15 mol %, preferably less than 10 mol %, more preferably less than 5 mol %, more preferably less than 3 mol %, more preferably less than 2 mol %, and most preferably has less than 1.5 mol % or is even completely free of Structure (III) relative to a 100% of the moles of Structure (I).

In an especially preferred embodiment, Structure (II) has less than 15 mol %, preferably less than 10 mol %, more preferably less than 5 mol %, more preferably less than 3 mol %, more preferably less than 2 mol %, and most preferably has less than 1.5 mol % or is even completely free of Structure (III) relative to a 100% of the moles of Structure (IV).

Structure (III) or (IV) cannot be polymerized and gives a false signal of the polymer and needs to be minimized or eliminated. This is demonstrated in Example 32 for Structure (III).

The one or more fluorescent monomers may be polymerized into the water treatment polymer in the range of no greater than 10 mol % of all monomers in the water treatment polymer; in another aspect no greater than 5 mol %, in still another aspect no greater than 2 mol %, in still another aspect no greater than 1 mol %. The one or more fluorescent monomers may be polymerized into the water treatment polymer in the range of no less than 0.001 mol %; in another aspect no less than 0.005 mol %, in still another aspect no less than 0.01 mol %, in still another aspect no less than 0.05 mol % of all monomers in the water treatment polymer.

Phosphorous-Containing Moieties

Optional phosphorus-containing moieties that can be incorporated into the polymer may be derived from any one or more of polymerizable phosphonate-containing monomers, phosphinic acid, phosphinate groups, phosphonic acid or phosphonate groups.

Polymerizable phosphonate monomers include without limitation vinyl phosphonic acid and vinyl diphosphonic acid, isopropenyl phosphonic acid, isopropenyl phosphonic anhydride, (meth)allylphosphonic acid, ethylidene diphosphonic acid, vinylbenzylphosphonic acid, 2-(meth)acrylamido-2-methylpropyl phosphonic acid, 3-(meth)acrylamido-2-hydroxypropylphosphonic acid, 2-(meth)acrylamidoethylphosphonic acid, benzyl phosphonic acid esters and 3-(meth)allyloxy-2-hydroxypropylphosphonic acid.

Phosphinic acid or phosphinate groups may be incorporated in the polymer as phosphino groups by including in the polymerization mixture molecules having the structure

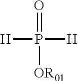

where R₀₁ is H, C₁-C₄ alkyl, phenyl, alkali metal or an equivalent of an alkaline earth metal atom, an ammonium ion or an amine residue. These moieties, which can incorporate phosphinic or phosphinate groups into the polymer, include but are not limited to hypophosphorous acid and its salts, such as sodium hypophosphite.

Phosphonic acid or phosphonate groups may be incorporated in the polymer by including in the polymerization mixture molecules having the structure

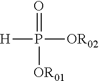

where R₀₁ or R₀₂ are independently H, C₁-C₄ alkyl, phenyl, alkali metal or an equivalent of an alkaline earth metal atom, an ammonium ion or an amine residue. These moieties include but are not limited to orthophosphorous acid and its salts and derivatives such as dimethyl phosphite, diethyl phosphite and diphenyl phosphite.

The one or more phosphorous moieties may be present in the water treatment polymer in the range of no greater than 20 mol %; in another aspect no greater than 10 mol %, in still another aspect no greater than 5 mol %, in still another aspect no greater than 3 mol %, and may not be present.

Sulfonic Acid Monomers

Optional water-soluble sulfonic acid monomers include but are not limited to one or more of 2-acrylamido-2-methyl propane sulfonic acid (′AMPS), vinyl sulfonic acid, sodium (meth)allyl sulfonate, sulfonated styrene, (meth)allyloxybenzene sulfonic acid, sodium 1-(meth allyloxy 2 hydroxy propyl sulfonate, (meth)allyloxy polyalkoxy sulfonic acid, (meth)allyloxy polyethoxy sulfonic acid and combinations thereof, and their salts. In various embodiments the sulfonic acid monomers can be present in the aqueous reaction medium before dosing of the fluorescent monomer—acid monomer solution begins, or can be mixed into the fluorescent monomer—acid monomer solution, or can be dosed into the polymerization mixture concurrently as a separate stream. In an embodiment, the sulfonic acid group can be incorporated in the polymer after polymerization. Examples of this type of sulfonic acid groups are sulfomethylacrylamide and sulfoethylacrylamide. For example, when the polymer contains acrylamide, the acrylamide moiety can react with formaldehyde and methanol to form sulfomethylacylamide.

In one embodiment, the amount of sulfonic acid monomer is less than 60 mole percent of the polymer, more preferably less than 40 mole percent of the polymer, more preferably less than 20 mole percent of the polymer and most preferably less than 10 mole percent of the polymer, and may not be present.

Nonionic Monomers

For purposes of this disclosure, a nonionic monomer is defined as a monomer not capable of developing a charge in water at any pH range. Non-ionic monomers suitable for use herein are preferably substantially free of amine groups. Nonionic monomers include water-soluble non-ionic monomers and low water solubility non-ionic monomers. The low water solubility non-ionic monomers are preferred.

As used herein with respect to water-soluble non-ionic monomers, water-soluble means that the monomer has a water solubility of greater than 6 grams per 100 mls of water at 25° C.

Examples of water-soluble non-ionic monomers include (meth)acrylamide, N,N-dimethylacrylamide, acrylonitrile, hydroxy alkyl (meth)acrylates such as hydroxyethyl (meth)acrylate and hydroxypropyl (meth)acrylate, vinyl alcohol typically derived from the hydrolysis of already polymerized vinyl acetate groups, ethoxylated (meth)allyl alcohol, (poly)alkoxylated (meth)acrylates such as poly(ethylene glycol)ₙ (meth)acrylate where n=1 to 100, preferably 3-50, and most preferably 5-20, ethoxylated alkyl, alkaryl or aryl monomers such as methoxypolyethylene glycol (meth)acrylate, 1-vinyl-2-pyrrolidone, vinyl lactam, allyl glycidyl ether, (meth)allyl alcohol, and others.

In one embodiment, the nonionic monomer is a low water solubility nonionic monomer which is defined as a nonionic monomer that has a water solubility of less than 6 g per 100 mls at 25° C., preferably less than 3 g per 100 mls at 25° C.

Examples of a low water solubility nonionic monomer include but are not limited to C₁-C₁₈ alkyl esters, C₂-C₁₈ alkyl-substituted (meth)acrylamides, aromatic monomers, alpha-olefins, C₁-C₆ alkyl diesters of maleic acid and itaconic acid, vinyl acetate, glycidyl methacrylate, (meth)acrylonitrile and others. C₁-C₁₈ alkyl esters of (meth)acrylic acid include but are not limited to methyl methacrylate, methyl acrylate, ethyl acrylate, n-butyl acrylate, n-butyl methacrylate, t-butyl acrylate and t-butyl methacrylate, 2-ethylhexyl (meth)acrylates, lauryl (meth)acrylate, stearyl (meth)acrylate and others. C₂-C₁₈ alkyl-substituted (meth)acrylamides include but are not limited to such as N,N-diethyl acrylamide, t-butyl acrylamide, and t-octyl acrylamide, and others. Aromatic monomers include but are not limited to styrene, alpha methylstyrene, benzyl (meth)acrylate and others. alpha-olefins include, propene, 1-butene, di isobutylene, 1 hexene and others. Preferred nonionic low water solubility monomers include styrene, methyl (meth)acrylate, di isobutylene, vinyl acetate, t-butyl acrylamide and ethyl acrylate.

In one embodiment, the amount of water-soluble nonionic monomer is no greater than 75 mole percent of the polymer, or no greater than 50 mole percent of the polymer, or no greater than 30 mole percent of the polymer, or may not be present.

In one embodiment, the amount of low water solubility nonionic monomer is no greater than 50 mole percent of the polymer, or no greater than 20 mole percent of the polymer, or no greater than 15 mole percent of the polymer, or no greater than 10 mole percent of the polymer or may not be present.

In one embodiment of the polymerization method as disclosed herein, water-soluble nonionic monomers can be present in the aqueous reaction medium before dosing of the fluorescent monomer—acid monomer solution begins.

In one embodiment of the polymerization method as disclosed herein, low water solubility nonionic monomers can be mixed into the fluorescent monomer—acid monomer solution before it is dosed to the aqueous reaction medium.

In one embodiment of the polymerization method as disclosed herein, any of the nonionic monomers can be dosed to the aqueous reaction medium as a separate dosing stream concurrently with the dosing of the fluorescent monomer—acid monomer solution.

Fluorescent Monomer Compositions

Advantageously, the non-quaternized fluorescent monomers used herein are soluble in compositions of acrylic acid or methacrylic acid that are essentially water free. This allows for the preparation of fluorescent monomer—acid monomer solutions that can be used as feed streams for the polymerization reaction to make the desired fluorescent water treatment polymers.

In another aspect, it is possible to have solutions of the low water-soluble fluorescent monomers as disclosed herein in solutions of acrylic acid or methacrylic acid or mixtures thereof, wherein the fluorescent monomer is present at a concentration higher than would be used in a polymerization reaction. Such solutions would facilitate ease of handling and storage of the fluorescent monomers prior to their use in a polymerization reaction, and could then be diluted with additional acid monomer and optionally other additional monomers to prepare monomer feed streams for the polymerization reaction in accordance with the method as disclosed herein. Such concentrated solutions could include at least 2 wt % fluorescent naphthalimide monomer, or at least 4 wt % fluorescent naphthalimide monomer, or at least 6 wt % fluorescent naphthalimide monomer, or at least 8 wt % fluorescent naphthalimide monomer, or at least 10 wt % fluorescent naphthalimide monomer, in a naphthalimide fluorescent monomer—acid monomer solution, wherein the acid monomer is acrylic acid, methacrylic acid, or a mixture thereof. In one embodiment such concentrated fluorescent naphthalimide monomer solutions contain less than 10 wt % water, or less than 5 wt % water, or less than 1 wt % water, or contain no detectable water.

In one embodiment, the disclosure relates to a fluorescent monomer composition, suitable as a premix in a process for preparing the disclosed water-soluble fluorescent polymers, wherein the fluorescent monomer composition comprises:
(a) one or more fluorescent monomers selected from

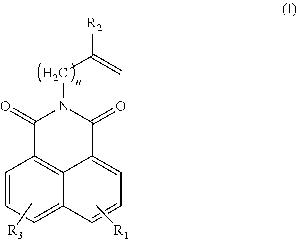

wherein R₁ and R₃ are independently selected from H, hydroxy, alkoxy, aryloxy, arylalkoxy, alkylaryloxy, amino, alkylamino, arylamino, arylalkylamino, alkylarylamino, pyrrolyl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or methyl,
n=0-10, and is preferably 1, and
m=1-10;
and

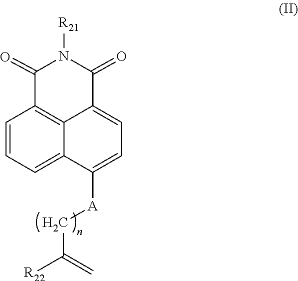

wherein A is selected from —(NR23)-, or —O—, and —O-alk-aryl-,
R₂₃ is H or alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, (—OCH₂CHR₂₄)ₘ—O—C₁-C₄alk, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-,
R₂₂ and R₂₄ are independently H or C₁-C₆ alkyl, and
(b) a solvent comprising acrylic acid, methacrylic acid, or a mixture thereof,
wherein said composition comprises at least 2 wt % of said one or more fluorescent monomers.

In a preferred embodiment, the fluorescent monomer is incorporated into the water treatment polymer to an extent that the unreacted fluorescent monomer is as low as possible or undetectable. The unreacted fluorescent monomer will give a false signal of the polymer and needs to be minimized or eliminated.

It is important to measure the amount of unreacted fluorescent monomer at the end of every polymerization reaction. It is important to take samples during the reaction and measure the unreacted fluorescent monomer over the reaction to ensure as even an incorporation of the fluorescent monomer as possible as well as ensuring minimum amount of unreacted fluorescent monomer. If the unreacted fluorescent monomer is higher than desired, it can be minimized in a number of ways. The feed rate of the fluorescent monomer relative to the other monomers needs to be adjusted to get even incorporation of the fluorescent monomer as well as make sure that the residual fluorescent monomer is minimized. If the fluorescent monomer concentration is increasing during the reaction, it means that the other monomers are preferably reacting with themselves. In that case shorten the fluorescent monomer feed time and/or lengthen the feed time of the other monomers. This gives the fluorescent monomer a better chance of reacting with the other (presumably more reactive) monomers. If however, the fluorescent monomer is being used up too quickly, the opposite needs to be done. In that case lengthen the fluorescent monomer feed time and/or shorten the feed time of the other monomers. This gives the fluorescent monomer a better chance of reacting with the other (presumably more less reactive) monomers.

One skilled in the art will realize that monomers such as acrylic acid or 2-acrylamido-2-methyl propane sulfonic acid are reactive and may leave unreacted fluorescent monomer especially if it has allylic groups. In this case, a part of the fluorescent monomer may be added to the charge and the other part fed by itself or with the other monomers or the monomers feed adjusted as detailed above.

In most cases, it is not preferred to have all of the fluorescent monomer in the initial charge. However, if both the fluorescent monomer as well as the other monomer are unreactive, then they both may go in to the charge. Such is the case when the fluorescent monomer is allylic and the other monomer is unreactive such as maleic acid or allylic such as (meth)allyl sulfonate and others.

The initiator feed needs to be as long as the total monomer feed or may exceed the monomer feed by 15-30 minutes. Other ways to minimize the unreacted fluorescent monomer include but are not limited to increasing the temperature, increasing the concentration of the initiator relative to the total amount of monomer, or changing the type of initiator. In addition, the finding the optimum pH to react the fluorescent monomer may help. Adding a water miscible cosolvent such as glycols or an alcohol like an isopropyl alcohol will help especially if the unreacted fluorescent monomer contains an aromatic group (besides the naphthalimide group).

In a preferred embodiment, the fluorescent monomer is incorporated into the water treatment polymer to an extent of at least 80%, at least 90%, more preferably at least 95%, more preferably at least 97%, more preferably at least 98%, more preferably at least 99% and most preferably is undetectable.

In another preferred embodiment, the fluorescent monomer has Structure (I) and has less than 10 mol %, 5 mol %, 3 mol %, or less than 2 mol %, in each case based on 100 mol % of Structure (I), of Structure (III); and the fluorescent monomer is incorporated into the water treatment polymer to an extent of at least 90%, 95%, 97%, or at least 98%, or at least 99%. In an especially preferred embodiment, the fluorescent monomer has Structure (I) and has less than 2 mol %, based on 100 mol % of Structure (I), of Structure (III); and the fluorescent monomer is incorporated into the water treatment polymer to an extent of at least 98%.

In another preferred embodiment, the fluorescent monomer has Structure (II) and has less than 10 mol %, 5 mol %, 3 mol %, or less than 2 mol %, in each case based on 100 mol % of Structure (II), of Structure (VI); and the fluorescent monomer is incorporated into the water treatment polymer to an extent of at least 90%, 95%, 97%, or at least 98%, or at least 99%. In an especially preferred embodiment, the fluorescent monomer has Structure (II) and has less than 2 mol %, based on 100 mol % of Structure (II), of Structure (VI); and the fluorescent monomer is incorporated into the water treatment polymer to an extent of at least 98%.

Use of the Water Treatment Polymers to Inhibit Scale

It is an advantage of the method disclosed herein that the polymerization end product is an aqueous solution of a water-soluble fluorescent water treatment polymer.

The polymer compositions may be added to the industrial water systems or may be formulated into various water treatment formulations which may then be added to the industrial water systems. In certain industrial water systems where large volumes of water are continuously treated to maintain low levels of deposited matter, the polymers may be used at levels as low as 0.5 ppm (parts per million). The upper limit on the level of polymer used will be dependent upon the particular aqueous system to be treated. For example, when used to disperse particulate matter the polymer may be used at levels ranging from 0.5 ppm to 2,000 ppm. When used to inhibit the formation or deposition of mineral scale the polymer may be used at levels ranging from 0.5 ppm to 100 ppm, preferably from 3 ppm to 20 ppm, more preferably from 5 ppm to 10 ppm.

Once prepared, the water-soluble polymers can be incorporated into a water treatment formulation comprising about 10-25 wt % of the water-soluble polymer and optionally other water treatment chemicals. Water treatment formulations may contain other ingredients such as corrosion inhibitors. These corrosion inhibitors can inhibit corrosion of copper, steel, aluminum, or other metals that may be present in the water treatment system. Azoles are typically used in these water treatment formulations as copper corrosion inhibitors. The benzotriazole is typically formulated in acidic formulations. The tolyl triazole is formulated in alkaline formulations. If a corrosion inhibitor is used, the formulator will choose a pH range suitable for the selected corrosion inhibitor, to achieve the desired solubility of these azoles, in the selected pH ranges. One skilled in the art will recognize that other azoles or non azole-containing copper corrosion inhibitors may be used in combination with these polymers. In addition, corrosion inhibitors that inhibit corrosion of other metals also can be used.

The fluorescent emissions of the treated water system are then monitored. Such monitoring can be accomplished using known techniques as disclosed, for example, in U.S. Pat. Nos. 5,171,450, 5,986,030, and 6,280,635. Fluorescent monitoring such as in-line monitoring allows the user to monitor the amount of water treatment polymer used to mitigate carbonate scale in the aqueous system. As indicated above, the level of the fluorescent polymer utilized in the water treatment compositions will be determined by the treatment level desired for the particular aqueous system to be treated. Conventional water treatment compositions are known to those skilled in the art. Once created, the fluorescent water-soluble polymers can be used as scale inhibitors in any industrial water system where a scale inhibitor is needed.

The other monomers of the fluorescent water treatment polymers as disclosed herein can be selected to provide water treatment polymers that are effective in the inhibition of any one or more of carbonate scale, phosphate scale, silica scale, and sulfate scale. In one embodiment the water treatment polymer is used to inhibit carbonate scale. In one embodiment the water treatment polymer is used to inhibit phosphate scale. One skilled in the art of water treatment polymers will understand how to select the carboxylic acid monomer and the other monomers of the water treatment polymer to optimize scale inhibition depending on the type of scale present in the system being treated. In general, polymers containing carboxylic acid monomers with or without phosphorus groups are good for carbonate and sulfate scale. Polymers containing carboxylic acid and sulfonic acid and polymers containing carboxylic acid, sulfonic acid and nonionic monomers are good for phosphate scale.

One skilled in the art will recognize that the fluorescent water treatment polymers of the disclosed method can be used in formulations containing inert tracers. These tracers include but are not limited to, 2-naphthalene sulfonic acid, rhodamine, Fluorescein and 1,3,6,8-Pyrenetetrasulfonic acid, tetrasodium salt (PTSA). This allows for complete monitoring of the system as described in U.S. Pat. Nos. 5,171,450 and 6,280,635.

Use of the Water Treatment Polymers for Flocculation and Coagulation

Polymers for flocculation and coagulation comprise at least one water soluble cationic ethylenically unsaturated monomer and/or at least one water soluble non-ionic monomer, as described above.

As used herein, the term “cationic ethylenically unsaturated monomer” means an ethylenically unsaturated monomer which is capable of developing a positive charge in an aqueous solution or always has a positive charge because it is quaternized. In an embodiment of the present disclosure, the cationic ethylenically unsaturated monomer has at least one amine functionality.

As used herein, the term “amine salt” means that the nitrogen atom of the amine functionality is covalently bonded to from one to three organic groups and is associated with an anion.

As used herein with respect to water soluble non-ionic or cationic monomers for flocculation or coagulation purposes, “water soluble” means that the monomer has a water solubility of greater than 6 grams per 100 mls of water at 25° C.

The cationic ethylenically unsaturated monomers include, but are not limited to, N,N dialkylaminoalkyl(meth)acrylate, N-alkylaminoalkyl(meth)acrylate, N,N dialkylaminoalkyl(meth)acrylamide and N-alkylaminoalkyl(meth)acrylamide, where the alkyl groups are independently C₁₋₁₈ linear, branched or cyclic moieties. Aromatic amine containing monomers such as vinyl pyridine may also be used. Furthermore, acyclic monomers such as vinyl formamide, vinyl acetamide and the like which generate amine moieties on hydrolysis may also be used. Preferably the cationic ethylenically unsaturated monomer is selected from one or more of N,N-dimethylaminoethyl methacrylate, tert-butylaminoethylmethacrylate, N,N-dimethylaminopropyl methacrylamide, 3-(dimethylamino)propyl methacrylate, 2-(dimethylamino)propane-2-yl methacrylate, 3-(dimethylamino)-2,2-dimethylpropyl methacrylate, 2-(dimethylamino)-2-methylpropyl methacrylate and 4-(dimethylamino)butyl methacrylate and mixtures thereof. The most preferred cationic ethylenically unsaturated monomers are N,N-dimethylaminoethyl methacrylate, tert-butylaminoethylmethacrylate and N,N-dimethylaminopropyl methacrylamide.

Examples of cationic ethylenically unsaturated monomers that are quaternized include but are not limited to: dimethylaminoethyl (meth)acrylate methyl chloride quaternary salt, dimethylaminoethyl (meth)acrylate benzyl chloride quaternary salt, dimethylaminoethyl (meth)acrylate methyl sulfate quaternary salt, dimethylamino propyl (meth)acrylamide methyl chloride quaternary salt, dimethylamino propyl (meth)acrylamide methyl sulfate quaternary salt, diallyl dimethyl ammonium chloride, (meth)acrylamidopropyl trimethyl ammonium chloride and others.

Examples of water soluble non-ionic monomers for this purpose include (meth)acrylamide, N,N dimethylacrylamide, acrylonitrile, hydroxy alkyl (meth)acrylates such as hydroxyethyl (meth)acrylate and hydroxypropyl (meth)acrylate, vinyl alcohol typically derived from the hydrolysis of already polymerized vinyl acetate groups, 1-vinyl-2-pyrrolidone, vinyl lactam, allyl glycidyl ether, (meth)allyl alcohol, and others. The preferred monomer is (meth)acrylamide. High molecular weight polyarylamide polymers are typically produced by inverse emulsion polymerization. The fluorescent monomers of this disclosure can be incorporated into these polymers by dissolving these monomers into the acrylamide aqueous phase of the polymerization process.

When the polymers are used for coagulation or flocculation in a water treatment system, the method comprises the steps of:
(a) dosing the water system with the water treatment polymer; and
(b) monitoring the fluorescent signal emitted from the water treatment system.

Use of the Water Treatment Polymers for Cleaning Applications

Polymers for cleaning applications are formed from at least one non-quaternized fluorescent naphthalimide derivative monomer, as herein described. In one embodiment, the disclosure relates to a method for determining whether a given location has been cleaned comprising the steps of:
(a) applying the polymer to the location;
(b) cleaning the location at least once; and
(c) attempting to detect the presence of the fluorescent naphthalimide derivative remaining at the location after said cleaning, which, presence, if detected, indicates that additional cleaning is needed.

Ideally, if fluorescent naphthalimide derivative is detected as remaining at the location after cleaning, the location should be cleaned again as necessary until residual fluorescent naphthalimide derivative can no longer be detected, which failure to detect residual fluorescent naphthalimide derivative indicates the location is completely clean.

In one embodiment, the polymer is provided as a part of a film-forming composition that quickly dries on the surface to be cleaned, is transparent, and is easily removed, but not by incidental contact. The film deposited on the surface fluoresces under ultraviolet light due to the presence of the fluorescent naphthalimide derivative and can be easily visualized by inspection with a hand-held UV light emitting light source, such as a UV flashlight.

Suitable compositions and their preparation and use are described in US 2016/0002525, the entire contents of which are incorporated herein by reference. Typically, the composition will contain a solvent and a thickener. A ready-to-use formulation will in one embodiment contain from about 1 to about 30 wt. % of a fluorescent polymer; from about 60 to about 99 wt. % of a solvent; and from about 0.05 to about 1 wt. % of a thickener. Preferably, the ready to use composition comprises from about 4 to about 25 wt. % of a fluorescent polymer; from about 50 to about 95 wt. % of a solvent; and from about 0.1 to about 0.4 wt. % of a thickener. More preferably, the ready to use composition comprises from about 8 to about 16% of a fluorescent polymer; from about 67 to about 91 wt. % of a solvent; from about 0.1 to about 0.4 wt. % of the thickener; from about 0.1 to about 0.7 wt. % of a preservative; and an optional pH adjusting agent. The composition can also be formulated as a concentrate, in which case, the weight ratio of the fluorescent polymer to surfactant, fluorescent polymer to thickener, or other relative proportions of ingredients will remain the same as in the ready-to-use composition, but the composition will contain a lesser amount of solvent.

In one embodiment, the solvent is preferably selected from water, methanol, ethanol, n-propanol, isopropanol, n-butanol, 2-butanol, isobutanol, n-pentanol, amyl alcohol, 4-methyl-2-pentanol, 2-phenylethanol, n-hexanol, 2-ethylhexanol, benzyl alcohol, ethylene glycol, ethylene glycol phenyl ether, ethylene glycol mono-n-butyl ether acetate, propylene glycol, propylene glycol mono and dialkyl ethers, propylene glycol phenyl ether, propylene glycol diacetate, dipropylene glycol, dipropylene glycol mono and dialkyl ethers, tripropylene glycol mono and dialkyl ethers, 1,3-propanediol, 2-methyl-1,2-butanediol, 3-methyl-1,2-butanediol, glycerol, methyl formate, ethyl formate, n-propyl formate, isopropyl formate, n-butyl formate, methyl acetate, n-propyl acetate, isopropyl acetate, isobutyl acetate, methyl lactate, ethyl lactate, propyl lactate, dimethylformamide, n-propyl propionate, n-butyl propionate, n-pentyl propionate, amyl acetate, methyl ethyl ketone, methyl isobutyl ketone, diisobutyl ketone, ethylamine, ethanolamine, diethanolamine, formic acid, acetic acid, propanoic acid, butanoic acid, acetone, acetonitrile, acetaldehyde, dimethyl sulfoxide, tetrahydrofuran, or a mixture thereof.

In one especially preferred embodiment, the solvent comprises water. The water can be from any source, including deionized water, tap water, softened water, and combinations thereof. The amount of water in the composition ranges from about 40 to about 99 wt. %, preferably from about 60 to about 95 wt. %, and more preferably from about 70 to about 90 wt. %.

In one embodiment, the thickener is preferably selected from xanthan gum, guar gum, modified guar, a polysaccharide, pullulan, an alginate, a modified starch, hydroxypropyl cellulose, hydroxypropyl methyl cellulose, carboxymethyl cellulose, hydroxyethyl cellulose, hydrophobically modified hydroxyethyl cellulose, hydrophobically modified hydroxypropyl cellulose, a polyacrylate, a vinyl acetate/alcohol copolymer, casein, a urethane copolymer, dimethicone PEG-8 polyacrylate, poly (DL-lactic-co-glycolic acid), a polyethylene glycol, a polypropylene glycol, pectin, or a combination thereof.

The composition can also include surfactants, preservatives, pH adjusting agents, and combinations thereof.

### Examples—Fluorescent Monomers

In some of the monomer synthesis where 4-Chloro-1,8-naphthalic anhydride was used it was obtained from Alfa Aesar and had a >94% purity. The 4-chloro-1,8-naphthalic anhydride was found to have approximately 4 area % of 4, 5-dichloro-1,8-naphthalic anhydride as measured by GC/MS. The 4, 5-dichloro-1,8-naphthalic anhydride will produce a monomer structure where R₁ and R₃ are both not H which has a stronger fluorescence signal than a monomer where R₁ and R₃ are independently selected from H and another substituent. Therefore, it is advantageous to have a higher fraction of 4, 5-dichloro-1,8-naphthalic anhydride in the starting 4-chloro-1,8-naphthalic anhydride material. It has 1.9 area % of 1,8-naphthalic anhydride as measured by GC/MS. It is advantages to minimize the amount of 1,8-naphthalic anhydride in the 4-chloro-1,8-naphthalic anhydride to minimize the impurity of Structure (IV).

The sample of Allyl Amine used in some of the monomer synthesis was obtained from Sigma-Aldrich and had 98% purity. It has 1 area % of ammonia as measured by GC/MS (Polymer Example 32). It is advantageous to minimize the amount of ammonia to minimize the Structure (III) impurity.

### Monomer Example 1: Synthesis of N-allyl-naphthalimide (R₁, R₃ and R₂ are H and n=1 in Structure I)

Procedure

Naphthalic anhydride (30.5 grams, 0.1514 mol, Sigma-Aldrich) was placed in a 2 L five neck flask. DMF (dimethylformamide) (355.7 grams, Acros Organics) and 4-methoxyphenol (0.3 gram, 0.0024 mol, Sigma-Aldrich) were added. The flask was fitted with a thermocouple, temperature controller, heating mantle, mechanical stirrer, addition funnel, condenser, and nitrogen inlet/outlet. The addition funnel was charged with allylamine (9.132 grams, 0.1599 mol, Sigma-Aldrich). The flask was heated to 50° C. (naphthalic anhydride was not completely dissolved), and then the allylamine was added over 45 minutes. The mixture was a clear orange solution when the allylamine addition was complete. It got hazy in 10 minutes. Toluene (100.8 grams, Sigma-Aldrich) was added, and a Dean-Stark distillation head was placed between the flask and the condenser. The flask was heated to 110° C. and slight vacuum (730 torr) was applied. 7 grams of water and 107 grams of toluene/DMF were distilled out resulting in an orange clear solution weighing 325.7 g, of which 10 wt % was the N-allyl naphthalimide product.

An aliquot (11.3 grams) was taken out to isolate a dry product by stripping the solvent. An NMR analysis of the dry product confirmed the target structure.

A 20 mg sample of the dried product was dissolved in 1.0 ml of dimethyl formamide for direct analysis by split injection GC/MS using the procedure described below.

| | |
|---|---|
| Column | Agilent Fused Silica Capillary DB-5 30M × 320 um |
| | 0.25 um |
| Oven Program | 40° C. Initial Hold 0 Minutes, 10° C./Minute to |
| | 300° C. |
| Injection Port | 280° C. |
| Split Flow | 60 ml/min |
| Carrier | Helium, 10.9 psi, 2.4 ml/min |
| Detection | Agilent 7890 MS, EI, 20 amu to 600 amu |

Using the MS detector for area % analysis, the purity of the N-allyl-naphthalimide product as estimated by area percent of the total ion signal was found to be 95.6%. Any impurity of Structure (III) if present was below the level of detection.

### Monomer Example 2: Synthesis of N-allyl-4-methoxy-1,8-naphthalimide (R₁ is Methoxy and R₃ and R₂ are H and n=1 in Structure I)

### Step I: Synthesis of N-allyl-4-chloro-1,8-naphthalimide

117.2 grams of 4-chloro-1,8-naphthalic anhydride (0.5045 mole) and 1095 grams of toluene were added into a flask equipped with an addition funnel, mechanical stirrer, heating mantle, thermocouple, and nitrogen inlet/outlet. The mixture was heated to 50° C. 30.44 g of allylamine (0.5331 mole) was placed in the addition funnel and the slow addition of allylamine was started. The allylamine was added over 40 minutes, and the addition funnel was rinsed with 50 grams of toluene. The addition funnel was replaced with a Dean-Stark trap. The temperature was gradually raised to 110° C., and the reaction mixture was heated at this temperature for 8 hours; 6.21 grams of water was distilled out along with 60 mL of toluene. A sample was taken out from the reaction mixture for ¹H-NMR analysis to check the progress of the reaction, and based on the NMR analysis 6 mL of allylamine added to complete the reaction. After the addition of allylamine, the reaction was heated at 110° C. for one hour, and ¹H-NMR showed the completion of the reaction. Toluene was stripped from the reaction mixture to afford a dry product. The final product, 136.09 grams, was obtained as a dry yellow powder (99.2% yield).

A 20 mg of sample of the dried product was dissolved in 1.0 ml of dimethyl formamide for direct analysis by split injection GC/MS using the conditions and procedures as described in Monomer Example 1.

Using the MS detector for area % analysis, the sample as estimated by area percent of the total ion signal was found to be 95.6% N-allyl-4-chloro-1,8-naphthalimide and 0.9% 1,8-naphthalimide.

### Step II: Synthesis of N-allyl-4-methoxy-1,8-naphthalimide

20.12 grams of the reaction product of Step I (approx. 0.07405 mole) and 99.86 grams methanol were placed in a reactor equipped with an addition funnel, magnetic stirrer, heating mantle, thermocouple, and nitrogen inlet/outlet. 30 mL of sodium methoxide solution 30 wt % in methanol (0.162 mole) was placed in the addition funnel and was then added to the reactor over one hour. The temperature of the reaction mixture rose from 20° C. to 26° C. during the addition. The reaction mixture was then heated to 65° C. for one hour, the reaction mixture was not homogeneous. The reaction progress was checked by TLC. The TLC showed the starting material, so an additional 10 mL of sodium methoxide was added to the reaction mixture. The reaction mixture was refluxed for two hours. TLC analysis showed no starting material. After cooling down, toluene (100 grams) was added to the mixture. Water was added and the resultant mixture was extracted with ethyl acetate (150 ml, 5 times). The solvents were stripped from the organic layer by rotary evaporator and 52 g of a wet solid was obtained. This solid was recrystallized using 130 mL of iso-propanol under reflux and a yellow solid was collected by vacuum filtration. The final product was 16 grams (80.8 yield). A sample of the dried product was dissolved in methanol at about 4 mg/ml and analyzed by HPLC/UV/ELSD/MS under the following conditions:

| | |
|---|---|
| Column | Agilent Poroshell 120 EC-C8 4 mm × 50 mm 2.7 |
| | micron |
| Column Oven | 40° C. |
| Mobile Phase | A—25 mm ammonium formate pH 3.0 in 20% |
| | acetonitrile/80% water |
| | B—Acetonitrile |
| Gradient | Time 0 70% A/30% B |
| | Time 10 40% A/60% B |
| Run Time | 8 |
| Flow Rate | 1 ml/min |
| Injection | 1 ul |
| Sample | 4 mg in 1 ml methanol |
| Detection | Agilent G1365C 1260 MWD, 300 nm, 4 nm width, |
| | reference 450 nm, 50 nm width |
| | Agilent 6550 Q-TOF Positive Ion |

N-allyl-4-methoxy-1,8-naphthalimide product was present as 90.5% by area %. N-allyl-4,5-dimethoxy-1,8-naphthalimide product was 3.7% by area % (R₁ and R₃ is methoxy and R₂ is H and n=1 in Structure I); this is also a useful monomer. The known impurity was N-allyl-4-chloro-1,8-naphthalimide at 2.4 area %. The impurity 4-methoxy-1,8-naphthalimide [Structure (III)] was not detected.

### Monomer Example 2a: Solubility in Acrylic Acid

The solubility of the monomer reaction product of Monomer Example 2 in acrylic acid was measured in the following manner. 10 g of acrylic acid was taken and the dried monomer reaction product of Monomer Example 2 was added in 0.2 g aliquots. The Monomer Example 2 reaction product started to become insoluble after 1.39 g was added. Next, 0.5 g of acrylic acid was added to form a clear solution. The final solution had 1.39 g of reaction product of Example 2 in 10.5 g of acrylic acid. The weight of reaction product of Example 2 was 11.7% of the total solution weight.

### Monomer Example 3: Synthesis of N-allyl-4-propoxy-1,8-naphthalimide (R₁ is Propoxy and R₃ and R₂ H and n=1 in Structure I)

### Step I: Synthesis of N-allyl-4-chloro-1,8-naphthalimide

117.2 grams of 4-Chloro-1,8-naphthalic anhydride (0.5045 mole) and 1095 grams of toluene were added into a flask equipped with an addition funnel, mechanical stirrer, heating mantle, thermocouple, and nitrogen inlet/outlet. The mixture was heated to 50° C. 30.44 g of allylamine (0.5331 mole) was placed in the addition funnel and the slow addition of allylamine was started. The allylamine was added over 40 minutes, and the addition funnel was rinsed with 50 grams of toluene. The addition funnel was replaced with a Dean-Stark trap. The temperature was gradually raised to 110° C., and the reaction mixture was heated at this temperature for 8 hours; 6.21 grams of water was distilled out along with 60 mL of toluene. A sample was taken out from the reaction mixture for ¹H-NMR analysis to check the progress of the reaction, and based on the NMR analysis 6 mL of allylamine added to complete the reaction. After the addition of allylamine, the reaction was heated at 110° C. for one hour, and ¹H-NMR showed the completion of the reaction. Toluene was stripped from the reaction mixture to afford a dry product. The final product, 136.09 grams, was obtained as a dry yellow powder (99.2% yield).

### Step II: Synthesis of N-allyl-4-propoxy-1,8-naphthalimide

Potassium hydroxide (27.92 grams, 0.4976 mole) was placed in a flask equipped with a nitrogen inlet/outlet, thermocouple, heating mantle, and magnetic stirrer. n-propanol (600 grams) was added to the flask. The mixture was stirred at 50° C. to dissolve potassium hydroxide. After potassium hydroxide was completely dissolved, a sample of the dried product of Step I (30.15 grams, approx. 0.1110 mole) was added to the solution as powder in one shot. n-propanol (20 grams) was used to rinse it in. The reaction was heated at 55° C., and monitored by TLC analysis. After 8 hours reaction, TLC analysis indicated incomplete reaction, so potassium hydroxide (2.62 grams, 0.0467 mole) was added to the reaction, the reaction was held at 55° C. for an additional 1.5 hours. The starting material was almost consumed. The reaction was cooled down overnight.

After cooling down to room temperature, the product precipitated out from the solution. The solid product was collected by filtration, washed with water, and vacuum dried to provide a yellow powder product. A sample of the dried product was dissolved in methanol at about 4 mg/ml and analyzed by HPLC/UV/ELSD/MS under the following conditions:

| | |
|---|---|
| Column | Agilent Poroshell 120 EC-C8 4 mm × 50 mm 2.7 |
| | micron |
| Column Oven | 40° C. |
| Mobile Phase | A—25 mm ammonium formate pH 3.0 in 20% |
| | acetonitrile/80% water |
| | B—Methanol |
| Gradient | Time 0 70% A/30% B |
| | Time 10 35% A/65% B |
| | Time 15 15% A/85% B |
| Run Time | 16 |
| Flow Rate | 1 ml/min |
| Injection | 2 ul |
| Sample | 3 mg in 1 ml methanol |
| Detection | Agilent G1365C 1260 MWD, 300 nm and 254 nm, 4 |
| | nm width, no reference |
| | Agilent 6550 Q-TOF Positive Ion |

The identified substances are listed in the table below:

| Identification | Area % |
|---|---|
| N-ally-4-chloro-1,8-naphthalimide | 0.35% |
| N-allyl-4-propoxy-1,8-naphthalimide | 96.24% |
| N-allyl-4,5-dipropoxy-1,8-naphthalimide | 1.26% |
| N-allyl-4-chloro-5-propoxy-1,8-naphthalimide | 0.46% |
| N-allyl-4-chloro-5-propoxy-1,8-naphthalimide* | 1.26% |

The structure of N-allyl-4-propoxy-1,8-naphthalimide was confirmed by ¹H-NMR analysis. Any impurity of Structure (III) if present was below the level of detection.

GC/MS and LC/FLD Procedures:

The sample of this example was initially analyzed by LC/MS to identify the retention times of target peaks. The same sample was then analyzed using similar, but weaker LC conditions by LC/FLD. The first step was to collect emission spectra with zero order excitation, this allows determining the emission maximum, which was 410 nm for the N-allyl-4-propoxy-1,8-naphthalimide and 450 nm for the N-allyl-4,5-dipropoxy-1,8-naphthalimide species.

The next step was to collect excitation spectra at the emission maximum for each compound. This allows determining the individual excitation maximum, which was 375 nm and 395 nm for the N-allyl-4-propoxy-1,8-naphthalimide and the N-allyl-4,5-dipropoxy-1,8-naphthalimide species respectively. The final step is to collect a chromatogram at the individual excitation and emission maxima. The latter two steps are each done with time programming the wavelengths, so each only require a single chromatogram.

Then the sample was analyzed by GC/MS to estimate the actual concentrations of the two components of interest. The ratio of the area percent by fluorescence and mass spec is the estimated relative fluorescence intensity. By ratioing the GC/MS and LC/FLD normalized area percent, the relative fluorescent intensity of the N-allyl-4,5-dipropoxy-1,8-naphthalimide to N-allyl-4-propoxy-1,8-naphthalimide was found to be 5.6. This assumes that the GC/MS area percent is the actual weight percent, which should be a close approximation.

Therefore, the disubstituted species has a stronger fluorescence signal than the mono substituted species, which is completely unexpected. Therefore, higher the amount of the disubstituted species in the mixture of mono and disubstituted species the stronger the signal from the fluorescence monomer.

LC Conditions

| | |
|---|---|
| Column | Agilent Porashell C8 4 mm × 50 mm |
| Mobile Phase | A—25 mm AF pH 3.0 in 20% Acetonitrile |
| | B—Methanol |
| LC/UV/MS | 40% A/60% B |
| LC/FLD | 45% A/55% C |
| Sample | 3 mg/ml in isopropanol, diluted 10× for some work |

GC/MS Conditions

| | |
|---|---|
| Column | 30M × 0.32 mm 0.5 um DB-5 |
| Oven Program | 70 C. hold 1 min 15 C./min to 150 C. 10 C./min to |
| | 320 C. |
| Injection | Splitless |

### Monomer Example 4: Synthesis of N-propyl-4-allyloxy-1,8-naphthalimide (R₂₁ is propyl, A is 0, n=1 and R₂₂ is H in Structure II)

### Step 1: Synthesis of N-propyl-4-chloro-1,8-naphthalimide

4-chloro-1,8-naphthalic anhydride (101.7 g, 0.437 mol) and 709.5 g of toluene were added into a flask equipped with an addition funnel, nitrogen inlet/outlet, thermocouple, heating mantle, and mechanical stirrer. Propyl amine (31.1 g, 0.526 mol) was placed in the addition funnel and the slow addition of propyl amine was started. The propyl amine was added over 45 minutes, and the addition funnel was rinsed with 55 g of toluene. The addition funnel was replaced with a Dean-Stark trap and the temperature was gradually raised to 110° C. and held for ˜8 hours. The reaction was cooled down to room temperature overnight and at this point very little water had been distilled and starting material was still present based on FTIR analysis. An additional 5.5 g (0.093 mol) propyl amine was added and the mixture was stirred at 55° C. for 1 hour before gradually increasing to 110° C. and holding for 3.5 hours. To go to higher reaction temperatures, xylene was added for solvent exchange and the temperature was raised to 125° C. for toluene removal. Once the majority of the toluene had been replaced with xylene, the reaction was cooled to 40° C. and an additional 26 g (0.440 mol) of propyl amine was added and held at this temperature for 2 hours. The reaction was heated further to 145° C. and monitored by FTIR. In total, 116.4 g (1.97 mol) of propyl amine was needed for complete consumption of the starting anhydride. Xylene was stripped from the reaction mixture to give a dry yellow powder. The final product was analyzed by LC-UV, and the purity was 97.5% (LC-UV area).

### Step 2: Synthesis of N-propyl-4-allyloxy-1,8-naphthalimide

Potassium hydroxide (7.83 g, 0.1400 mol) and allyl alcohol (313.43 g, 5.40 mol) were placed in a flask equipped with a nitrogen inlet/outlet, thermocouple, heating mantle, and mechanical stirrer. The mixture was stirred at 50° C. to dissolve potassium hydroxide. After potassium hydroxide was completely dissolved, the dried reaction product of Step I (53.93 g, approx. 0.197 mol) was added to the solution as a powder in one shot. The reaction was heated at 55° C. and monitored by TLC analysis. After 3 hours at temperature, TLC analysis indicated incomplete reaction. Additional potassium hydroxide (3.38 g, 0.0602 mol) was added and the reaction was heated further to 60° C. Additional sampling called for four more additions of potassium hydroxide (total KOH added=27.58 g, 0.4915 mol) and the reaction was at 55-60° C. for a total of 22 hours. After cooling down to room temperature, the product precipitated out from solution. The solid product was collected by vacuum filtration and the flask was washed with isopropanol. The solids were collected and washed with water to remove potassium chloride salts that were formed. The mixture was once again filtered and the resulting solids were dried with vacuum, yielding a yellow powder product. A sample of the dried product was dissolved in methanol at about 4 mg/ml and was analyzed by LC-UV under the following conditions:

| | |
|---|---|
| Column | Agilent Poroshell 120 EC-C8 4 mm × 50 mm 2.7 |
| | micron |
| Column Oven | 40° C. |
| Mobile Phase | A—25 mm ammonium formate pH 3.0 in 20% |
| | acetonitrile/80% water |
| | B—Acetonitrile |
| Gradient | Time 0 70% A/30% B |
| | Time 10 40% A/60% B |
| Run Time | 16 |
| Flow Rate | 1 ml/min |
| Injection | 1 ul |
| Sample | 4 mg in 1 ml isopropanol |
| Detection | Agilent G1365C 1260 MWD, 300 nm and 254 nm, 4 |
| | nm width, no reference |
| | Agilent 6550 Q-TOF Positive Ion |

The identified substances are listed in the table below:

| Identification | Area % |
|---|---|
| N-propyl-4-allyloxy-1,8-naphthalimide | 87% |
| N-propyl-4,5-diallyloxy-1,8-naphthalimide | 1.2% |
| N-propyl-4-chloro-5-allyloxy-1,8-naphthalimide | 1.0% |
| N-propyl-1,8-naphthalimide Structure (IV) | 1.9% |

N-propyl-1,8-naphthalimide Structure (IV) is present because the starting 4-chloro-1,8-naphthalic anhydride has 1,8-naphthalic anhydride as an impurity due to incomplete chlorination. Thus, Structure (IV) impurities can be minimized by using 4-chloro-1,8-naphthalic anhydride or 4-bromo-1,8-naphthalic anhydride with a minimum amount of 1,8-naphthalic anhydride. This can be achieved by over chlorinating or brominating the 1,8-naphthalic anhydride since the disubstituted derivatives 4,5-dichloro-1,8-naphthalic anhydride such as give disubstituted final products such as N-propyl-4,5-diallyloxy-1,8-naphthalimide which have a stronger signal than the monosubstituted derivatives such as N-propyl-4-allyloxy-1,8-naphthalimide.

### Monomer Example 5: Synthesis of N-allyl-4-(methoxy, triethylene glycol) 1,8-naphthalimide (R₁ is (Methoxy, Triethylene Glycol) and R₃ and R₂ are H and n=1 in Structure I)

### Step I: Synthesis of N-allyl-4-chloro-1,8-naphthalimide

117.2 grams of 4-chloro-1,8-naphthalic anhydride (0.5045 mole) and 1095 grams of toluene were added into a flask equipped with an addition funnel, mechanical stirrer, heating mantle, thermocouple, and nitrogen inlet/outlet. The mixture was heated to 50° C. 30.44 g of allylamine (0.5331 mole) was placed in the addition funnel and the slow addition of allylamine was started. The allylamine was added over 40 minutes, and the addition funnel was rinsed with 50 grams of toluene. The addition funnel was replaced with a Dean-Stark trap. The temperature was gradually raised to 110° C., and the reaction mixture was heated at this temperature for 8 hours; 6.21 grams of water was distilled out along with 60 mL of toluene. A sample was taken out from the reaction mixture for ¹H-NMR analysis to check the progress of the reaction, and based on the NMR analysis 6 mL of allylamine added to complete the reaction. After the addition of allylamine, the reaction was heated at 110° C. for one hour, and ¹H-NMR showed the completion of the reaction. Toluene was stripped from the reaction mixture to afford a dry product. The final product, 136.09 grams, was obtained as a dry yellow powder (99.2% yield).

### Step II: Synthesis of N-allyl-4-(methoxy, triethylene glycol) 1,8-naphthalimide

In a 250-mL 4-necked flask with mechanical stirring, 3.02 g (75.5 mmol, 10% excess) of ˜60% sodium hydride in mineral oil was charged. The solid was washed several times with small amounts of hexanes, decanting carefully by pipet each time, to remove the oil. Next, 33.0 g (201 mmol) of triethylene glycol monomethyl ether (TEGME) was added to the flask, swept by nitrogen, as hydrogen gas bubbled forth, forming a brown solution of the sodium salt of TEGME at 71° C. After allowing this to cool, 18.6 g (68.6 mmol) of the dried reaction product of Step I was slowly added in small portions at 36-40° C. (mild exotherm) over 15 min. Following this another 2.0 g of TEGME was added. The temperature of the green suspension was brought to 50° C. for 3 hr before neutralizing with 75 drops of acetic acid and adding 35 g of deionized water to the well-stirred thick mixture. The more mobile green slurry was cooled to ˜10° C., filtered, and the solids were stirred up and washed twice with a total of 30 mL of cold water. After air drying the solid overnight, and then under vacuum for 7 hr, it was recrystallized by dissolving in 20 mL of hot toluene and then adding 10 mL of hexanes. Standing at ambient temperature overnight produced brown crystals that were crushed before filtration and washed with ˜1:1 toluene-hexane. Vacuum drying for 5 hr gave 21.7 g of yellow-brown powder. ¹H NMR confirmed that N-allyl-4-(methoxy, triethylene glycol) 1,8-naphthalimide was synthesized. A sample of the dried product was dissolved in 50% isopropanol/50% water at about 6 mg/ml and was analyzed by LC-UV under the following conditions:

| | |
|---|---|
| Column | Agilent Poroshell 120 EC-C8 4 mm × 50 mm 2.7 |
| | micron |
| Column Oven | 40° C. |
| Mobile Phase | A—25 mm ammonium formate pH 3.0 in 20% |
| | acetonitrile/80% water |
| | B—Acetonitrile |
| Gradient | Time 0 70% A/30% B |
| | Time 10 40% A/60% B |
| Run Time | 16 |
| Flow Rate | 1 ml/min |
| Injection | 1 ul |
| Sample | 4 mg in 1 ml isopropanol |
| Detection | Agilent G1365C 1260 MWD, 300 nm and 254 nm, 4 |
| | nm width, no reference |
| | Agilent 6550 Q-TOF Positive Ion |

HPLC/MS (area %) indicated that the sample comprised 89.7% N-allyl-4-(methoxy, triethylene glycol) 1,8-naphthalimide, 2.4% N-allyl-1,8-naphthalimide, and 1% N-allyl-4-chloro-1,8-naphthalimide, with unidentified peaks making up the remainder. The solubility of the reaction mixture of this Example in water was found to be less than 0.1 grams per 100 mis of water at 25° C. at pH 7.

### Monomer Example 6: Synthesis of N-allyl-4-butylamino-1,8-naphthalimide (R₁ is butylamino and R₃ and R₂ are H and n=1 in Structure I)

### Step I: Synthesis of N-allyl-4-chloro-1,8-naphthalimide

117.2 grams of 4-chloro-1,8-naphthalic anhydride (0.5045 mole) and 1095 grams of toluene were added into a flask equipped with an addition funnel, mechanical stirrer, heating mantle, thermocouple, and nitrogen inlet/outlet. The mixture was heated to 50° C. 30.44 g of allylamine (0.5331 mole) was placed in the addition funnel and the slow addition of allylamine was started. The allylamine was added over 40 minutes, and the addition funnel was rinsed with 50 grams of toluene. The addition funnel was replaced with a Dean-Stark trap. The temperature was gradually raised to 110° C., and the reaction mixture was heated at this temperature for 8 hours; 6.21 grams of water was distilled out along with 60 mL of toluene. A sample was taken out from the reaction mixture for ¹H-NMR analysis to check the progress of the reaction and based on the NMR analysis 6 mL of allylamine added to complete the reaction. After the addition of allylamine, the reaction was heated at 110° C. for one hour, and ¹H-NMR showed the completion of the reaction. Toluene was stripped from the reaction mixture to afford a dry product. The final product, 136.09 grams, was obtained as a dry yellow powder (99.2% yield).

The sample was prepared for analysis by dissolving 20 mg of sample in 1.0 ml of dimethyl formamide. It was analyzed by split injection GC/MS with listed conditions. The concentrations were estimated by area percent of the total ion signal.

| | |
|---|---|
| Column | Agilent Fused Silica Capillary DB-5 30M × 320 um |
| | 0.25 um |
| Oven Program | 40° C. Initial Hold 0 Minutes, 10° C./Minute to |
| | 300° C. |
| Injection Port | 280° C. |
| Split Flow | 60 ml/min |
| Carrier | Helium, 10.9 psi, 2.4 ml/min |
| Detection | Agilent 7890 MS, EI, 20 amu to 600 amu |

The area % of N-allyl-4-chloro-1,8-naphthalimide was found to be 95.6% and the area of 1,8-naphthalimide was found to be 0.9%.

### Step II: Synthesis of N-allyl-4-butylamino-1,8-naphthalimide

A sample of the dried product of Step I (10.17 grams, approx. 0.0374 mole), dimethyl sulfoxide (50 mL), and n-butylamine (36 mL, 26.64 grams, 0.3642 mole, Aldrich) were mixed in a flask equipped with a nitrogen inlet/outlet, thermocouple, and heating mantle. The mixture was heated to 80° C. The mixture became homogeneous at 35° C. After 4 hours of reaction at this temperature, the reaction was checked by TLC. Consumption of the starting material was confirmed and a new spot, assumed the target molecule, was observed very bright under a UV light.

The reaction mixture was added to 400 mL of water slowly with stirring to precipitate the product. The precipitated yellow/orange solid was collected by vacuum filtration. After vacuum drying the filtered solid 11.56 grams of bright yellow powder was obtained. (100% recovery yield)

The ¹H-NMR spectrum of the product in CDCl₃ confirmed the target structure. Residual DMSO was observed from the spectrum, estimated at 3.2 wt % in the sample.

The sample was analyzed by HPLC/UV/ELSD/MS after dissolution in methanol at about 2 mg/mL. The purity of the N-allyl-4-butylamino-1,8-naphthalimide product was 92.5% by area %. The key impurities were N-allyl-1,8-naphthalimide 1.03% by area % and N-allyl-4-chloro-1,8-naphthalimide 3.04% by area %.

HPLC conditions are listed:

| | |
|---|---|
| Column | Agilent Poroshell 120 EC-C8 4 mm × 50 mm 2.7 |
| | micron |
| Column Oven | 40° C. |
| Mobile Phase | A—25 mm ammonium formate pH 3.0 in 20% |
| | acetonitrile |
| | B—methanol |
| Gradient | Time 0 100% A/0% B |
| | Time 10 30% A/70% B |
| Run Time | 9 |
| Flow Rate | 1 ml/min |
| Injection | 1 ul |
| Sample | 2 mg in 1 ml methanol |
| Detection | Agilent G1365C 1260 MWD, 300 nm, 4 nm width, |
| | reference 450 nm, 50 nm width |
| | Agilent 6550 Q-TOF Positive Ion |

### Monomer Example 7

### N-(3-dimethylaminopropyl)-4-allyloxy-1,8-naphthalimide

In Structure II R₂₁ is dimethylaminopropyl, A is O and n=1, R₂₂ is H

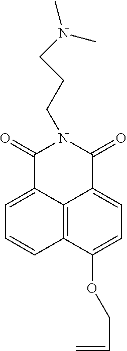 [SMILES: C=CCOc1ccc2c3c(cccc13)C(=O)N(CCCN(C)C)C2=O]

### Step 1: Synthesis of N-(3-dimethylaminopropyl)-4-chloro-1,8-naphthalimide

A flask equipped with an addition funnel nitrogen inlet/outlet, thermocouple, magnetic stirrer, and heating mantle, 48.9 g of 4-chloro-1,8-naphthalic anhydride (0.2102 mol) and 700 mL of toluene was added. Next, 22.6 g of N-dimethylaminopropyl (DMAPA) (0.2212 mol) was placed in the addition funnel and was slowly added to the flask at room temperature. An exotherm from 22° C. to 32° C. was observed during the addition.

The addition funnel was replaced with a Dean-Stark distillation head. The reaction mixture was then heated to 45° C. for 30 minutes, and the temperature was gradually raised to 60° C. for 45 minutes, 70° C. for 69 minutes, 90° C. for 140 minutes, 110° C. for 135 minutes, and 115° C. for 85 minutes. The reaction mixture was checked with TLC at different points during the reaction and stopped when the anhydride was no longer present. A total of 1.6 grams of water was distilled off.

The solvent was stripped by rotary evaporation, and after vacuum treatment of the resulting wet solid gave 65.6 g of a yellow dry powder (0.2070 mol, 99% yield). ¹H-NMR spectrum of the product confirmed the target structure.

### Step 2: Synthesis of N-(3-dimethylaminopropyl)-4-allyloxy-1,8-naphthalimide

Potassium hydroxide (7.83 g, 0.1400 mol) and allyl alcohol (313.43 g, 5.40 mol) were placed in a flask equipped with a nitrogen inlet/outlet, thermocouple, heating mantle, and mechanical stirrer. The mixture was stirred at 50° C. to dissolve potassium hydroxide. After potassium hydroxide was completely dissolved, the dried reaction product of Step I (66.6 g, approx. 0.197 mol) was added to the solution as a powder in one shot. The reaction was heated at 55° C. and monitored by TLC analysis. After 3 hours at temperature, TLC analysis indicated incomplete reaction. Additional potassium hydroxide (3.38 g, 0.0602 mol) was added and the reaction was heated further to 60° C. Additional sampling called for four more additions of potassium hydroxide (Total KOH added=27.58 g, 0.4915 mol) and the reaction was at 55-60° C. for a total of 22 hours. After cooling down to room temperature, the product was precipitated out from solution. The solid product was collected by vacuum filtration and the flask was washed with isopropanol. The solids were collected and washed with water to remove potassium chloride salts that were formed. The mixture was once again filtered and the resulting solids were dried with vacuum, yielding a powder product.

### Monomer Example 8

### N-allyl-3-Nitro-1,8-naphthalimide

Into a 250-mL 3-necked flask was charged 100 mL of toluene and 50.7 g (208.5 mmol) of 99% 3-nitro-1,8-naphthalic anhydride. Into this suspension was syringed 18.3 mL (14.3 g, 250 mmol) of allylamine under nitrogen. The temperature rose from 24° C. to 50° C. as the beige slurry became very thick.

Another 20 mL of toluene was added as the mixture heated, and it refluxed into a Dean-Stark trap to remove water. After 3 hr, 0.9 mL of water had collected and the mixture was cooled and transferred to a 500-mL flask.

A 50-100 mL portion of N,N-dimethylformamide (DMF) was added to promote solubility of the nitro-anhydride, and heating resumed at 113-125° C. A total of 6.0 mL of water was collected after 2.3 hr, and then the brown solution was stripped on a rotary evaporator at 57°/20 mm to leave a moist brown solid.

The solid was recrystallized from hot toluene and air dried to give 53.4 g (90.7% yield) of light brown powder, substantially pure N-allyl-3-nitro-1,8-naphthalimide by HPLC and ¹H NMR.

### Monomer Example 9

### Synthesis of N-Allyl-3-amino-1,8-naphthalimide (R₁ is amino and R₃ and R₂ are H and n=1 in Structure I)

In a 250-mL 4-necked flask with mechanical stirrer was placed 11.3 g (40.0 mmol) of the N-allyl-3-nitro-1,8-naphthalimide and 40 g of ethanol. To this was added 37.9 g (200 mmol) of anhydrous tin(II) chloride (Aldrich 99.99%) and the slurry was brought to 50° C. under N₂. No obvious changes occurred, but on warming to 70° C. an exotherm brought the temperature to 78° C. temporarily.

The resulting darker brown, cloudy solution was heated at 70° C. for 1 hour and then diluted with water and treated with 32.0 g (400 mmol) of 50% NaOH to yield a slightly greenish thick slurry that tested pH 7 to paper. This slurry was extracted (triturated) 8 times with ethyl acetate, and the combined organic phase was evaporated to 6.6 g of N-Allyl-3-amino-1,8-naphthalimide, which appeared to be substantially pure by ¹H NMR.

### Monomer Example 10: Synthesis of N-allyl-4-(2-methoxyethoxy)-1,8-naphthalimide

### Step I: Synthesis of N-allyl-4-chloro-1,8-naphthalimide

117.2 grams of 4-chloro-1,8-naphthalic anhydride (0.5045 mole) and 1095 grams of toluene were added into a flask equipped with an addition funnel, mechanical stirrer, heating mantle, thermocouple, and nitrogen inlet/outlet. The mixture was heated to 50° C. 30.44 g of allylamine (0.5331 mole) was placed in the addition funnel and the slow addition of allylamine was started. The allylamine was added over 40 minutes, and the addition funnel was rinsed with 50 grams of toluene. The addition funnel was replaced with a Dean-Stark trap. The temperature was gradually raised to 110° C., and the reaction mixture was heated at this temperature for 8 hours; 6.21 grams of water was distilled out along with 60 mL of toluene. A sample was taken out from the reaction mixture for ¹H-NMR analysis to check the progress of the reaction and based on the NMR analysis 6 mL of allylamine added to complete the reaction. After the addition of allylamine, the reaction was heated at 110° C. for one hour, and ¹H-NMR showed the completion of the reaction. Toluene was stripped from the reaction mixture to afford a dry product. The final product, 136.09 grams, was obtained as a dry yellow powder (99.2% yield).

### Step II: Synthesis of

### N-allyl-4-(2-methoxyethoxy)-1,8-naphthalimide

Into a 250-mL 4-necked flask under N₂, 30.0 g (0.394 mol) of 2-methoxyethanol (Aldrich 99.3%) and a tiny spatula tip of solid NaBH₄ (to limit brown color development) was charged. After 5-10 min 7.61 g (0.119 mol, 2.18 eq) of 88% KOH pellets was added with good stirring at 35-58° C., and within approximately 20 minutes these pellets had dissolved to form a cloudy, medium yellow-brown solution, which was then cooled to 40° C.

14.8 g (0.0545 mol) of N-allyl-4-chloro-1,8-naphthalimide (87% purity) was then charged a little at a time to the well stirred mixture at 36-40° C., with no evidence of an exotherm. The heavy yellow-brown slurry was brought to 50° C. and it thinned out again. After 37 min and again after another hour, TLCs appeared identical, with apparently one main spot formed and very little starting material evident.

Neutralization ensued with addition of 3.9 g (0.065 mol) of glacial acetic acid to make a solution that when diluted with water measured pH 7-8 to paper. With good stirring, the reaction mixture was diluted with 35 g of deionized water, cooled to 25° C. and filtered through a 60-mL coarse-fritted funnel. The yellow solid was washed 3 times with a total of 45 mL of water and then dried 7 hr in a vacuum desiccator to 14.9 g solid. This solid material was found to be about 65 area % pure N-allyl-4-(2-methoxyethoxy)-1,8-naphthalimide by HPLC. 13.1 g of this solid was recrystallized from ethanol to give after drying 10.0 g of yellow powder. ¹H NMR showed that this was consistent with ˜95% purity of N-allyl-4-(2-methoxyethoxy)-1,8-naphthalimide.

### Monomer Example 11: Synthesis of N-allyl-4-(pyrrol-1-yl)-1,8-naphthalimide

### Step I: Synthesis of N-allyl-4-chloro-1,8-naphthalimide

117.2 grams of 4-chloro-1,8-naphthalic anhydride (0.5045 mole) and 1095 grams of toluene were added into a flask equipped with an addition funnel, mechanical stirrer, heating mantle, thermocouple, and nitrogen inlet/outlet. The mixture was heated to 50° C. 30.44 g of allylamine (0.5331 mole) was placed in the addition funnel and the slow addition of allylamine was started. The allylamine was added over 40 minutes, and the addition funnel was rinsed with 50 grams of toluene. The addition funnel was replaced with a Dean-Stark trap. The temperature was gradually raised to 110° C., and the reaction mixture was heated at this temperature for 8 hours; 6.21 grams of water was distilled out along with 60 mL of toluene. A sample was taken out from the reaction mixture for ¹H-NMR analysis to check the progress of the reaction and based on the NMR analysis 6 mL of allylamine added to complete the reaction. After the addition of allylamine, the reaction was heated at 110° C. for one hour, and ¹H-NMR showed the completion of the reaction. Toluene was stripped from the reaction mixture to afford a dry product. The final product, 136.09 grams, was obtained as a dry yellow powder (99.2% yield).

### Step II: Synthesis of N-allyl-4-(pyrrol-1-yl)-1,8-naphthalimide

N-allyl-4-chloro-1,8-naphthalimide (5.4 grams, 0.0199 mol), pyrrole (12.43 grams, 0.1853 mol) and 70 mL of DMSO were placed in a 250 mL flask equipped with a heating mantle, thermocouple, magnetic stirrer, nitrogen inlet/outlet. Sodium hydroxide (0.97 gram, 0.02427 mol) was added to the mixture, and the mixture turned red. The mixture was then heated to 50° C. with stirring. After one hour at this temperature, thin layer chromatographic analysis indicated that the consumption of N-allyl-4-chloro-1,8-naphthalimide. The reaction mixture was poured into water and extracted with ethyl acetate. The organic layer was dried over sodium sulfate. After solvent strip, recrystallization of the product was performed from iso-propanol. A pure monomer was obtained 3.8 grams (63% recovery yield). LC-UV/MS analysis of the recrystallized material had 94.5 area % purity.

HPLC conditions are listed:

| | |
|---|---|
| Column | Agilent Poroshell 120 EC-C8 4 mm × 50 mm 2.7 micron |
| Column Oven | 40° C. |
| Mobile Phase | A-25 mm ammonium formate pH 3.0 in 20% acetonitrile |
| | B-methanol |
| Gradient | Time 0 100% A/0% B |
| | Time 10 30% A/70% B |
| Run Time | 9 |
| Flow Rate | 1 ml/min |
| Injection | 1 ul |
| Sample | 2 mg in 1 ml methanol |
| Detection | Agilent G1365C 1260 MWD, 300 nm, 4 nm width, |
| width | reference 450 nm, 50 nm |

Agilent 6550 Q-TOF Positive Ion

### Monomer Example 12: Synthesis of N-phenyl-4-methallyloxy-1,8-naphthalimide

### Step I: Synthesis of N-phenyl-4-chloro-1,8-naphthalimide

4-Chloro-1,8-naphthalic anhydride (21.98 grams, 0.0945 mol) and acetic acid 150 mL were placed in a flask equipped with a Dean-Stark distillation head, nitrogen inlet/outlet, heating mantle, thermocouple and magnetic stirrer. Aniline (9.33 grams, 0.1002 mol) was added to the flask. The reaction mixture was heated to 125° C. for 2 hours. IR analysis of the mixture confirmed disappearance of the anhydride. After cooling down to room temperature, the product precipitated out. The solid product was collected by vacuum filtration. The product was vacuum dried. 32.15 grams of the product was obtained. ¹H-NMR conformed the target structure.

### Step II: Synthesis of N-phenyl-4-methallyloxy-1,8-naphthalimide

N-phenyl-4-chloro-1,8-naphthalimide, about 5 grams was placed in a flask equipped with a magnetic stirrer, heating mantle, thermocouple, nitrogen inlet/outlet. Methallyl alcohol 250 mL, DMF 150 mL, and potassium hydroxide 3.5 g were added to the flask and the mixture was heated to 60° C. with stirring. TLC analysis of the mixture after 3 hours at this temperature indicated the presence of the starting material, DMF of 150 mL was added to the mixture and the temperature was raised to 70° C. After 4 additional hours at this temperature, the reaction mixture was cooled down and the solvents were evaporated using a rotary evaporator.

Obtained solids from the solvent stripping was triturated with water and the solid product was collected by vacuum filtration. The collected solid was recrystallized from a refluxed ethyl acetate solution. The crystallization did not happen at room temperature, the solution was left in a freezer overnight. The crystals were collected by vacuum filtration (2.16 g). LC-analysis of the sample indicated 70.0 area % (ELSD) of N-phenyl-4-methallyloxy-1,8-naphthalimide and 26.0 area % (ELSD) of the “dimethylaminno analogue”.

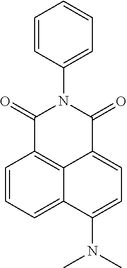 [SMILES: CN(C)c1ccc2c3c(cccc13)C(=O)N(c1ccccc1)C2=O]

HPLC conditions are listed:

| | |
|---|---|
| Column | Agilent Porashell C8 4 mm × 50 mm |
| Mobile phase | A-25 mm AF pH 3.0 in 20% ACN, B-MeOH |
| | Time 0 40% A/60% B |
| | Time 5% A/95% B |
| Detection | UV 300 nm and ELSD |
| Injection | 2 ul |
| Sample | 2 to 4 mg/ml in MeOH/THF |

### Monomer Example 13: Synthesis of N-(4-methoxyphenyl)-4-methallyloxy-1,8-naphthalimide

### Step I: Synthesis of N-(4-methoxyphenyl)-4-chloro-1,8-naphthalimide

4-Chloro-1,8-naphthalic anhydride (20.65 grams, 0.08877 mol) and acetic acid 150 mL were placed in a flask equipped with a Dean-Stark distillation head, nitrogen inlet/outlet, heating mantle, thermocouple and magnetic stirrer. p-Anisidine (13.73 grams, 0.08877 mol) was added to the flask. The reaction mixture was heated to 125° C. for 2 hours. IR analysis of the mixture confirmed disappearance of the anhydride. After cooling down to room temperature, the product precipitated out. The solid product was collected by vacuum filtration. The product was vacuum dried. 25.93 grams of the product was obtained. ¹H-NMR conformed the target structure.

### Step II: Synthesis of N-(4-methoxyphenyl)-4-methallyloxy-1,8-naphthalimide

Potassium hydroxide (3.72 g, 0.0663 mol) was placed in a round bottom flask equipped with a thermocouple and magnetic stirrer. β-methallyl alcohol (202.82 g, 2.815 mol) was added to the flask. The contents were heated to 65° C. via heating mantle under a low flow of nitrogen. Potassium hydroxide was dissolved and N-(4-methoxyphenyl)-4-chloro-1,8-naphthalimide (10.02 g, 0.0297 mol) was added to the solution. TLC analysis of the mixture showed no progress after 4 hours of heating at this temperature. DMF 250 mL was added to the mixture. The reaction mixture was heated at 76° C. for 6 hours. TLC of the reaction mixture indicated the trace of the starting material.

Crystals were obtained leaving the reaction mixture at room temperature overnight. The crystalline solid was collected by vacuum filtration (A, 7.00 g). The filtrate was rotary evaporated to dryness and the solids were washed with a copious amount of water, then vacuum filtered. The collected solid contained many materials based on TLC analysis, the solid was recrystallized from an ethyl acetate solution (B, 2.34 g).

LC analysis of the two isolated products showed that sample A contains 91.6 area % (UV) of the target monomer and 5.2 area % (UV) of the “dimethylamino analogue”. Sample B contains 85.8 area % (UV) of the target monomer and 9.4 area % (UV) of the “dimethylamino analogue”.

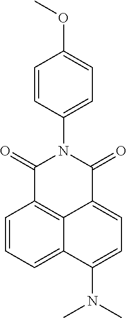 [SMILES: COc1ccc(N2C(=O)c3cccc4c(N(C)C)ccc(c34)C2=O)cc1]

HPLC conditions are listed:

| | |
|---|---|
| Column | Agilent Porashell C8 4 mm × 50 mm |
| Mobile phase | A—25 mm AF pH 3.0 in 20% ACN, |
| | B—ACN, |
| | C—MeOH |
| | Time 0 70% A/10% B/20% B |
| | Time 5 5% A/10% B/85% B |
| Detection | UV 300 nm |
| Injection | 2 ul |
| Sample | 2 mg/ml in MeOH/THF |

### Monomer Example 14: Synthesis of N-(2-(1-oxo-2-aza-4-pentenyl)-phenyl)-1,8-naphthalimide

### Step I: Synthesis of N-(2-carboxy-phenyl)-1,8-naphthalimide

1,8-Naphthalic anhydride (10.00 grams, 0.0505 mol), anthranilic acid (8.25 grams, 0.0602 mol), and dimethylformamide (600 mL) were placed in a flask equipped with a nitrogen inlet/outlet, reflux condenser, thermocouple, and heating mantle.

The mixture was stirred and heated to reflux (156° C.) for 7 hours. After the reflux, the reaction mixture was cooled down and poured into water to precipitate crude products. After filtration, 14.56 grams of solid was recovered. This solid contained 60 mol % of the target imide and 40 mol % of the anhydride (¹H and ¹³C-NMR analysis).

This solid was dissolved in 300 mL of acetic acid at 84° C. to recrystallize. After recrystallization, the pure material was obtained 9.98 grams (0.032 mol, 62% purified yield).

### Step II: Synthesis of N-(2-(1-oxo-2-aza-4-pentenyl)-phenyl)-1,8-naphthalimide (KS2921-23)

N-(2-carboxy-phenyl)-1,8-naphthalimide (5.00 grams, 0.0158 mol) and allylamine (1.1 grams, 0.0193 mmol) and dichloroethane, 200 mL were placed in a flask with a magnetic stir bar, thermometer, ice bath and nitrogen inlet/outlet.

Dicyclohexyl dicarbodimide (DCC, 1.0 M in dichloromethane 16.5 mL, 0.0165 mol) was added to the flask at 0° C. After the addition of DCC solution, the reaction mixture was warmed up to room temperature and kept stirred for overnight at this temperature.

After stripping the solvents, a crude solid product was obtained. Hexane was used to extract the target material from the crude solid product, but the hexane extract did not contain the target molecule by LC analysis. The solids (9.07 g) after extraction was extracted using diethyl ether, this ether extract was also not the target material.

The solid was put in a Soxhlet thimble and extracted with diethyl ether. The sample from Soxhlet ether extract (2.15 g) contained about 30% of the target molecule by LC analysis, and the solid left in the thimble (5.63 g) contained 60% of the target molecule by LC analysis.

The solid in the thimble was further extracted with diethyl ether using a Soxhlet apparatus and the insoluble left in the thimble had about 40 mol % of the target molecule by ¹³C-NMR analysis. (see Table). This sample weighed 4.28 grams.

TABLE
Purity of N-(2-(1-oxo-2-aza-4-pentenyl)-phenyl)-1,8-naphthalimide
sample by ¹³C-NMR

| Component | Mol % | Weight % |
|---|---|---|
| Product (see Structure A below) | 39.4 | 46.0 |
| Impurity (see Structure B below) | 9.7 | 16.6 |
| N,N′-dicyclohexylurea | 50.9 | 37.4 |

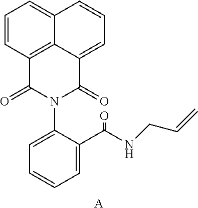

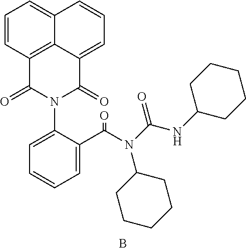

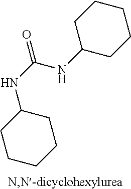

Structures in the Sample

NMR conditions are listed:

Varian MR-400 MHz NMR spectrometer

The sample was dissolved in a 50:50 (v/v) mixture of CD₃OD/CDCl₃ and analyzed by ¹³C NMR.

### Examples—Fluorescent Polymers

In the following Polymer Examples, stated quantities of fluorescent monomer are the quantities of the reaction products of the respective Monomer Examples.

### Polymer Example 1: Synthesis of a Polymer Containing N-allyl-naphthalimide

An initial charge of 190.1 g of deionized water was added to a 1-liter glass reactor with inlet ports for an agitator, water cooled condenser, thermocouple, and adapters for the addition of monomer and initiator solutions. The reactor contents were heated to 95° C. A mixed monomer solution which consisted of 298.4 g of acrylic acid (4.14 moles, 94.5 mole percent of polymer), 2.59 g of N-allyl-naphthalimide (Monomer Example 1, formula weight 237, 0.0109 moles, 0.25 mole percent of polymer) dissolved in 23.1 grams of DMF was mixed and then fed to the reactor via measured slow-addition with stirring over a period of 4 hours. A solution of 24.1 g of sodium hypophosphite monohydrate (0.23 moles, 5.28 mole percent of polymer) dissolved in 72 g of water was concurrently fed into the reactor over 4 hours starting at the same time as the monomer solution. An initiator solution of 6.68 grams of sodium persulfate dissolved in 72.4 grams water was concurrently added, starting at the same time as the monomer solution, for a period of 4 hours and 15 minutes. All three solutions were added to the reactor concurrently and sufficiently slowly so that gelation did not occur. The reaction product was then held at 95° C. for 60 minutes. The polymer solution was cooled and then neutralized with 40.1 g of 50% sodium hydroxide. The final polymerization reaction product was a clear solution which indicated the polymer was water-soluble. The solution had a solids content of about 49.2%, and a pH of 3.8.

### Polymer Example 2: Synthesis of a Polymer Containing N-allyl-naphthalimide

An initial charge of 190.3 g of deionized water was added to a 1-liter glass reactor with inlet ports for an agitator, water cooled condenser, thermocouple, and adapters for the addition of monomer and initiator solutions. The reactor contents were heated to 95° C. A mixed monomer solution which consisted of 298.4 g of acrylic acid (4.14 moles, 94.23 mole percent of polymer), 5.18 g of N-allyl-naphthalimide (Monomer Example 1, formula weight 237, 0.0218 moles, 0.5 mole percent of polymer) dissolved in 46.6 grams of DMF was mixed and then fed to the reactor via measured slow-addition with stirring over a period of 4 hours. A solution of 24.1 g of sodium hypophosphite monohydrate (0.23 moles, and 5.27 mole percent of polymer) dissolved in 72 g of water was concurrently fed into the reactor over 4 hours starting at the same time as the monomer solution. An initiator solution of 6.68 grams of sodium persulfate dissolved in 68.4 grams water was concurrently added, starting at the same time as the monomer solution, for a period of 4 hours and 15 minutes. The reaction product was then held at 95° C. for 60 minutes. The polymer solution was cooled and then neutralized with 88.3 g of 28% ammonium hydroxide. The final polymerization reaction product was a clear solution, had a solids content of about 41.2%, and a pH of 4.6.

### Example 3: Fluorescence Signal Strength

Polymer samples from Polymer Examples 1 and 2 were each diluted in water to 10 ppm and the fluorescent signal was determined by excitation of the sample at the excitation wavelengths and measurement at the emission wavelengths as stated in Table 1.

TABLE 1
Fluorescence data for polymer

| | Composition | Excitation | Emission | fluorescence |
|---|---|---|---|---|
| | (with mole percent of | wavelength | wavelength | signal/ppm |
| Polymer | each component) | nm | nm | polymer |
| Example 1 | AA/phosphino/N-allyl- | 330 | 403 | 2800 |
| | naphthalimide = | | | |
| | 94.5/5.28/0.25 | | | |
| Example 2 | AA/phosphino/N-allyl- | 330 | 403 | 7200 |
| | naphthalimide = | | | |
| | 94.23/5.27/0.5 | | | |

### Polymer Example 4

An initial charge of 152.6 g of deionized water and 152.6 g of isopropyl alcohol was added to a 1-liter glass reactor with inlet ports for an agitator, water cooled condenser, thermocouple, and adapters for the addition of monomer and initiator solutions. The reactor contents were heated to 84° C. (reflux). A mixed monomer solution was prepared in the following manner: 193.3 g of acrylic acid (2.68 moles, 93.22 mole percent of polymer) was weighed into a beaker and then, 2.13 g of N-allyl-4-methoxy-1,8-naphthalimide (Monomer Example 2) (0.0079 moles, 0.275 mole percent of polymer) was added with stirring and mixed until the fluorescent monomer was dissolved. The fluorescent monomer was 1.09 weight % of the solution containing fluorescent monomer and acrylic acid. 18.7 g of methyl methacrylate (0.187 moles, 6.5 mole percent of polymer) was then added to the solution. This mixed monomer solution was then fed to the reactor via measured slow-addition with stirring over a period of 4 hours. An initiator solution of 11.75 grams of sodium persulfate and 39.25 g of 35% hydrogen peroxide dissolved in 38.2 grams water was concurrently added, starting at the same time as the monomer solution, for a period of 4 hours. The reaction product was then held at 85° C. for 60 minutes. The polymer solution was then distilled to remove 244 g of a mixture of isopropyl alcohol and water. During the distillation, 41.6 g of 50% sodium hydroxide dissolved in 221 g water was added. The final polymer solution had a solids content of around 38.3% and a pH of 4.0.

### Polymer Example 5

An initial charge of 130 g of deionized water was added to a 1-liter glass reactor with inlet ports for an agitator, water cooled condenser, thermocouple, and adapters for the addition of monomer and initiator solutions. Next, 86.9 g of maleic anhydride (0.887 moles, 26.6 mole percent of polymer) was added to the reactor. 35.5 g of 50% sodium hydroxide was added drop wise to the reactor. The maleic dissolved as it was neutralized. 86.9 g of isopropyl alcohol was then added to the reactor. The reactor contents were heated to 84° C. (reflux). 0.081 g of ferrous ammonium sulfate hexahydrate was then added to the reactor. A mixed monomer solution was prepared in the following manner: 164.7 g of acrylic acid (2.29 moles, 68.5 mole percent of polymer) was weighed into a beaker and then, 1.32 g of N-allyl-4-methoxy-1,8-naphthalimide (Monomer Example 2) (0.0049 moles, 0.148 mole percent of polymer) was added with stirring and mixed until the fluorescent monomer was dissolved. The fluorescent monomer was 0.795 weight % of the solution containing fluorescent monomer and acrylic acid. 16 g of methyl methacrylate (0.16 moles, 4.8 mole percent of polymer) was then added to the solution with stirring. This mixed monomer solution was then fed to the reactor via measured slow-addition with stirring over a period of A mixed monomer solution which consisted of, and 4 hours. An initiator solution of 10 grams of sodium persulfate and 33.8 g of 35% hydrogen peroxide dissolved in 32.7 grams water was concurrently added, starting at the same time as the monomer solution, for a period of 4 hours. The reaction product was then held at 85° C. for 60 minutes. The polymer solution was then distilled to remove 222 g of a mixture of isopropyl alcohol and water. During the distillation, 200 g water was added. The final polymer solution had a solids content of around 49% and a pH of 3.0.

### Example 6: Carbonate Inhibition

Various polymers were evaluated for their ability to prevent the precipitation of calcium carbonate in typical cooling water conditions, a property commonly referred to as the threshold inhibition. Solutions were prepared in which the weight ratio of calcium concentration to alkalinity was 1.000:1.448 to simulate typical conditions in industrial water systems used for cooling. Generally, water wherein the alkalinity is proportionately less will be able to reach higher levels of calcium, and water containing a proportionally greater amount of alkalinity will reach lower levels of calcium. Since cycle of concentration is a general term, one cycle was chosen, in this case, to be that level at which calcium concentrations equaled 100.0 mg/L Ca as CaCO₃ (40.0 mg/L as Ca). The complete water conditions at one cycle of concentration (i.e., make-up water conditions) were as follows:

Simulated Make-Up Water Conditions:

100.00 mg/L Ca as CaCO₃ (40.0 mg/L as Ca) (one cycle of concentration)
49.20 mg/L Mg as CaCO₃ (12.0 mg/L as Mg)
2.88 mg/L Li as CaCO₃ (0.4 mg/L as Li)
144.80 M Alkalinity (144.0 mg/L as HCO₃)
13.40 P Alkalinity (16.0 mg/L as CO₃)

Materials:
One incubator/shaker, containing a 125 mL flask platform
Screw-cap Erlenmeyer Flasks (125 mL)
Deionized Water
Analytical balance
Electronic pipette(s) capable of dispensing between 0.0 mL and 2.5 mL
250 Cycle Hardness Solution *
10,000 mg/L treatment solutions, prepared using known active solids of the desired treatment *
10% and 50% solutions of NaOH
250 Cycle Alkalinity Solution*
0.2 μm syringe filters or 0.2 μm filter membranes
Volumetric Flasks (100 mL)
Concentrated Nitric Acid
   * See solution preparations in next section.

Solution Preparations:

All chemicals used were reagent grade and weighed on an analytical balance to ±0.0005 g of the indicated value. All solutions were made within thirty days of testing. The hardness and alkalinity solutions were prepared in a one liter volumetric flask using DI water. The following amounts of chemical were used to prepare these solutions—

250 Cycle Hardness Solution:

$$10 , 000 mg / L Ca ⇒ 36.6838 g {CaCl}_{2} {•2 H}_{2} O \\ 3 , 000 mg / L Mg ⇒ 25.0836 g {MgCl}_{2} {•6 H}_{2} O \\ 100 mg / L Li ⇒ 0.6127 g LiCl$$

250 Cycle Alkalinity Solution:

$$36 , 000 mg / L {HCO}_{3} ⇒ 48.9 \; 863 g {NaHCO}_{3} \\ 4 , 000 mg / L {CO}_{3} ⇒ 7.0 \; 659 g {Na}_{2} {CO}_{3}$$

10,000 mg/L Treatment Solutions:

Using percentage of active product in the supplied treatment, 250 mL of a 10,000 mg/L active treatment solution was made up for every treatment tested. The pH of the solutions was adjusted to between 8.70 and 8.90 using 50% and 10% NaOH solutions by adding the weighed polymer into a specimen cup or beaker and filling with DI water to approximately 90 mL. The pH of this solution was then adjusted to approximately 8.70 by first adding the 50% NaOH solution until the pH reached 8.00, and then by using the 10% NaOH until the pH equaled 8.70. The solution was then poured into a 250 mL volumetric flask. The specimen cup or beaker was rinsed with DI water and this water was added to the flask until the final 250 mL was reached. The amount of treatment product to be weighed was calculated as follows:

$$Grams of treatment needed = \frac{( 10 , 000 mg / L ) ( 0.25 L )}{( decimal \% of active treatment ) ( 1000 mg )}$$

Test Setup Procedure:

The incubator shaker was turned on and set for a temperature of 50° C. to preheat. Screw cap flasks were set out in groups of three to allow for triplicate testing of each treatment, allowing for testing of different treatments. The one remaining flask was used as an untreated blank.

96.6 grams of DI water was weighed into each flask.

Using a 2.5 mL electric pipette, 1.20 mL of hardness solution was added to each flask to simulate four cycles of make-up water.

Using a 250 μL electronic pipette, 200 μL of desired treatment solution was added to each flask to achieve a 20 ppm active treatment dosage. A new tip on the electric pipette was used for each treatment solution so cross contamination did not occur.

Using a 2.5 mL electric pipette, 1.20 mL of alkalinity solution was added to each flask to simulate four cycles of make-up water having an LSI value of 2.79. The addition of alkalinity was done while swirling the flask, so as not to generate premature scale formation from high alkalinity concentration pooling at the addition site.

One “blank” solution was prepared in the exact same manner as the above treated solutions, except DI water was added in place of the treatment solution.

All flasks uncapped were placed onto the shaker platform and the door closed. The shaker was run at 250 rpm and 50° C. for 17 hours.

A “total” solution was prepared in the exact same manner as the above treated solutions were prepared, except that DI water was used in place of both the treatment solution and alkalinity solution. This solution was capped and left overnight outside the shaker.

Test Analysis Procedure:

Once 17 hours had passed, the flasks were removed from the shaker and allowed to cool for one hour. Each flask solution was filtered through a 0.2 μm filter membrane. 250 μl of nitric acid was added to 10 ml of each filtrate, and each filtrate was analyzed directly for lithium, calcium, and magnesium concentrations by an Inductively Coupled Plasma (ICP) Optical Emission System. The “total” solution was analyzed in the same manner.

Calculations of Results:

Once the lithium, calcium, and magnesium concentrations were known in all shaker samples and in the “total” solution, the percent inhibition was calculated for each treatment. The lithium was used as a tracer of evaporation in each flask (typically about ten percent of the original volume). The lithium concentration found in the “total” solution was assumed to be the starting concentration in all flasks. The concentrations of lithium in the shaker samples were each divided by the lithium concentration found in the “total” sample. These results provided the multiplying factor for increases in concentration, due to evaporation. The calcium and magnesium concentrations found in the “total” solution were also assumed to be the starting concentrations in all flasks. By multiplying these concentrations by each calculated evaporation factor for each shaker sample, the final intended calcium and magnesium concentration for each shaker sample was determined. By subtracting the calcium and magnesium concentrations of the “blank” from both the actual and intended concentrations of calcium and magnesium, then dividing the resulting actual concentration by the resulting intended concentration and multiplying by 100, the percent inhibition for each treated sample was calculated. The triplicate treatments were averaged to provide more accurate results.

TABLE 2
Carbonate inhibition

| | % Carbonate | % Carbonate |
|---|---|---|
| | inhibition | inhibition |
| | (4 ppm | (5 ppm |
| Polymer | polymer) | polymer) |
| Example 1 | 95 | 100 |
| Example 2 | 92 | 100 |
| Example 4 | | 95 |
| Example 5 | | 94 |

In the test above, anything above 80% inhibition is considered acceptable. The data in Table 2 indicate that the carbonate inhibition performance of Polymer Examples 1, 2, 4 and 5 are excellent.

### Polymer Example 7

An initial charge of 86.9 g of maleic anhydride (0.89 moles, 24.95 mole percent of polymer) mixed with 130.0 g of deionized water was added to a 1-liter glass reactor with inlet ports for an agitator, water cooled condenser, thermocouple, and adapters for the addition of monomer and initiator solutions. The mixture was heated to 65° C. The maleic anhydride was neutralized using 35.5 g of 50% sodium hydroxide while keeping the temperature above 65° C. 130.0 g of isopropyl alcohol was then added to the reactor. Next, 0.0810 g of ferrous ammonium sulfate hexahydrate was added to the reactor. The reactor contents were heated to 84° C. A mixed monomer solution was prepared in the following manner: 164.6 g of acrylic acid (2.29 moles, 64.4 mole percent of polymer) was weighed into a beaker and then 1.32 g of N-allyl-4-methoxy-1,8-naphthalimide (Monomer Example 2, formula weight 267, 0.00494 moles, 0.14 mole percent of polymer) was added and mixed until the powdered fluorescent monomer dissolved. The fluorescent monomer was 0.795 weight % of the solution containing fluorescent monomer and acrylic acid. Next, 97.3 g of 2-acrylamido-2-methyl propane sulfonic acid sodium salt, 50% solution (0.21 moles, 6 mole percent of polymer) was added with mixing until a homogeneous solution was formed. Finally, 16 g of methyl methacrylate (0.16 moles, 4.5 mole percent of polymer) was added with mixing to form a homogeneous solution. This mixed monomer solution was then fed to the reactor via measured slow-addition with stirring over a period of 4 hours. An initiator solution of 10 grams of sodium persulfate and 33.8 g of 35% hydrogen peroxide was dissolved in 32.7 grams water was concurrently added, starting at the same time as the monomer solution, for a period of 4 hours. The reaction product was then held at 85° C. for 60 minutes. The reactor was then set up for distillation. An azeotropic of 222 g of a mixture of water and isopropyl alcohol was then distilled. 200 g of deionized water was dripping during the distillation. The final polymer solution had a solids content of 49.0% and a pH of 3.2.

### Polymer Example 8

An initial charge of 153.3 g of deionized water and 152.6 of isopropyl alcohol was added to a 1-liter glass reactor with inlet ports for an agitator, water cooled condenser, thermocouple, and adapters for the addition of monomer and initiator solutions. Next, 0.095 g of ferrous ammonium sulfate hexahydrate was added to the reactor. The reactor contents were heated to 84° C. A mixed monomer solution was prepared in the following manner: 193.3 g of acrylic acid (2.68 moles, 93.2 mole percent of polymer) was weighed into a beaker and then 2.13 g of N-allyl-4-methoxy-1,8-naphthalimide (formula weight 267, 0.00798 moles, 0.277 mole percent of polymer) (Monomer Example 2) was added with stirring until the powdered fluorescent monomer dissolved. The fluorescent monomer was 1.09 weight % of the solution containing fluorescent monomer and acrylic acid. Next, 18.8 g of ethyl acrylate (0.188 moles, 6.5 mole percent of polymer) added to the monomer solution above and was mixed. This monomer solution was then dosed to the reactor via measured slow-addition with stirring over a period of 4 hours. An initiator solution of 11.75 grams of sodium persulfate and 39.3 g of 35% hydrogen peroxide was dissolved in 38.3 grams water was concurrently added, starting at the same time as the monomer solution, for a period of 4 hours. The reaction product was then held at 85° C. for 60 minutes. The reactor was then set up for distillation. An azeotropic of 228 g of a mixture of water and isopropyl alcohol was then distilled. 41.6 g of 50% sodium hydroxide dissolved in 221.4 g of deionized water was dripping during the distillation. The final product was a clear polymer solution having a solids content of 38.2% and a pH of 4.0.

### Polymer Example 9

An initial charge of 130 g of deionized water and 130 of isopropyl alcohol was added to a 1-liter glass reactor with inlet ports for an agitator, water cooled condenser, thermocouple, and adapters for the addition of monomer and initiator solutions. Next, 0.08 g of ferrous ammonium sulfate hexahydrate was added to the reactor. The reactor contents were heated to 84° C. A mixed monomer solution was prepared in the following manner: 64.7 g of acrylic acid (2.29 moles, 93.2 mole percent of polymer) was weighed into a beaker and then 1.86 g of N-allyl-4-methoxy-1,8-naphthalimide (Monomer Example 2, formula weight 267, 0.00696 moles, 0.277 mole percent of polymer) and mixed until the powdered fluorescent monomer dissolved. The fluorescent monomer was 2.79 weight % of the solution containing fluorescent monomer and acrylic acid. Next, 97.3 g of 2-acrylamido-2-methyl propane sulfonic acid sodium salt, 50% solution (0.188 moles, 6.5 mole percent of polymer) was added with mixing until a homogeneous solution was formed. This mixed monomer solution was then fed to the reactor via measured slow-addition with stirring over a period of 4 hours. An initiator solution of 10 grams of sodium persulfate and 33.4 g of 35% hydrogen peroxide was dissolved in 35 grams water was concurrently added, starting at the same time as the monomer solution, for a period of 4 hours. The reaction product was then held at 85° C. for 60 minutes. The reactor was then set up for distillation. An azeotropic of 208 g of a mixture of water and isopropyl alcohol was then distilled. 35.4 g of 50% sodium hydroxide dissolved in 188.7 g of deionized water was dripped in during the distillation. The final product was a clear polymer solution having a solids content of 39.8% and a pH of 4.1.

### Polymer Example 10

An initial charge of 190.5 g of deionized water was added to a 1-liter glass reactor with inlet ports for an agitator, water cooled condenser, thermocouple, and adapters for the addition of monomer and initiator solutions. The reactor contents were heated to 95° C. A monomer solution was prepared by dissolving 3.19 g of N-allyl-4-methoxy-1,8-naphthalimide (Monomer Example 2, formula weight 267, 0.01194 moles, 0.27 mole percent of polymer) in 298.6 g of acrylic acid (4.14 moles, 94.4 mole percent of polymer). The fluorescent monomer was 1.06 weight % of the solution containing fluorescent monomer and acrylic acid. This monomer solution was added to the reactor over 4 hours. A second solution which consisted of 24.15 g of sodium hypophosphite monohydrate (0.23 moles, 5.3 mole percent of polymer) dissolved in 72 g of deionized water was mixed and then fed to the reactor concurrently over a period of 4 hours. An initiator solution of 6.78 grams of sodium persulfate dissolved in 68.5 grams water was concurrently added, starting at the same time as the monomer and hypophosphite solutions, for a period of 4 hours and 15 minutes. The reaction product was then held at 95° C. for 60 minutes. The polymer solution was cooled and then neutralized with and 20.2 g of 50% sodium hydroxide. The final product was a clear polymer solution having a solids content of about 47.5 and a pH of 3.7.

### Polymer Example 11: Polymerization Method B

An initial charge of 229.4 g of maleic anhydride (2.34 moles, 99.86 mole percent of polymer), 0.87 g of N-allyl-4-methoxy-1,8-naphthalimide (Monomer Example 2, formula weight 267, 0.00325 moles, 0.14 mole percent of polymer), mixed with 182.2 g of deionized water and 0.0575 g of ferrous ammonium sulfate hexahydrate was added to a 1-liter glass reactor with inlet ports for an agitator, water cooled condenser, thermocouple, and adapters for the addition of monomer and initiator solutions. The mixture was heated to 85° C. An initiator solution of 26 g of 35% hydrogen peroxide was added over the first hour. The reaction product was then heated to 95° C. An initiator solution of 153.15 g of 35% hydrogen peroxide was added over the next 4.5 hours. After the hydrogen peroxide feed was completed, the reaction was held at 95° C. for 45 minutes and then cooled to room temperature. The final product was a clear polymer solution.

### Example 12: Fluorescence Signal Strength

The polymer samples from the indicated Examples were diluted in water to 10 ppm and the pH adjusted to 9. The fluorescent signal was determined by excitation of the sample at the excitation wavelengths and measurement at the emission wavelengths as stated in Table 3.

TABLE 3
Fluorescence data for Polymer Examples

| | Composition | Excitation | Emission | fluorescence |
|---|---|---|---|---|
| | (with mole percent of | wavelength | wavelength | signal/ppm |
| Polymer | each component) | nm | nm | polymer |
| Example 4 | AA/MMA/methoxy | 373 | 457 | 14539 |
| | allyl naphthalimide = | | | |
| | 93.22/6.5/0.275 | | | |
| Example 5 | AA/maleic acid/MMA/ | 374 | 458 | 7310 |
| | methoxy allyl | | | |
| | naphthalimide = | | | |
| | 68.5/26.6/4.8/0.148 | | | |
| Example 7 | Maleic | 375 | 459 | 7499 |
| | acid/AA/MMA/AMPS/ | | | |
| | methoxy allyl | | | |
| | naphthalimide = | | | |
| | 24.95/64.4/4.5/6.0/0.14 | | | |
| Example 8 | AA/ethyl acrylate/ | 376 | 458 | 15761 |
| | methoxy allyl | | | |
| | naphthalimide = | | | |
| | 93.2/6.5/0.25 | | | |
| Example 9 | AA/AMPS/methoxy | 376 | 458 | 13032 |
| | allyl naphthalimide = | | | |
| | 93.2/6.5/0.25 | | | |
| Example 10 | AA/methoxy allyl | 374 | 461 | 14582 |
| | naphthalimide/ | | | |
| | phosphino = | | | |
| | 94.4/.27/5.3 | | | |
| Example 11 | Maleic acid/methoxy | 376 | 460 | 2422 |
| | allyl naphthalimide = | | | |
| | 99.86/0.14 | | | |
| Example 13 | AA/methoxy allyl | 375 | 460 | 13853 |
| | naphthalimide/AMPS = | | | |
| | 82.4/.26/17.3 | | | |
| Example 15 | AA/N-propyl-4- | 377 | 465 | 7468 |
| | allyloxy- | | | |
| | 1,8-naphthalimide/ | | | |
| | phosphino = | | | |
| | 94.6/.13/5.27 | | | |
| Example 16 | AA/N-propyl-4- | 379 | 464 | 7406 |
| | allyloxy- | | | |
| | 1,8-naphthalimide/ | | | |
| | phosphino = | | | |
| | 94.6/.14/5.26 | | | |
| Example 17 | AA/N-allyl-4- | 374 | 460 | 9109 |
| | (methoxy, | | | |
| | triethylene glycol) | | | |
| | 1,8-naphthalimide/ | | | |
| | phosphino = | | | |
| | 94.6/.14/5.26 | | | |
| Example 19 | AA/methoxy allyl | 376 | 459 | 17138 |
| | naphthalimide = | | | |
| | 99.72/.28 | | | |
| Example 20 | AA/N-allyl-4- | 375 | 461 | 4619 |
| | (methoxy, | | | |
| | triethylene glycol) | | | |
| | 1,8-naphthalimide/ | | | |
| | phosphino | | | |
| | 94.6/.082/5.29 | | | |
| Example 24 | AA/N-allyl-4-propoxy- | 376 | 462 | 18952 |
| | 1,8-naphthalimide/ | | | |
| | methoxy polyethylene | | | |
| | glycol 750 | | | |
| | methacrylate | | | |
| | 94.3/.30/5.42 | | | |

It may be seen that the polymers that include maleic acid have lower fluorescent signal strength as compared to those polymers that do not include maleic acid. Use of fluorescent polymers including low water-soluble fluorescent monomers and that do not include maleic acid could allow for the use of lower concentrations of the fluorescent monomer in the polymer while still providing a strong fluorescent signal for the user.

### Polymer Example 13

An initial charge of 125.6 g of deionized water and 53.7 of isopropyl alcohol was added to a 1-liter glass reactor with inlet ports for an agitator, water cooled condenser, thermocouple, and adapters for the addition of monomer and initiator solutions. The reactor contents were heated to 84° C. A mixed monomer solution was prepared in the following manner: 124.0 g of acrylic acid (1.72 moles, 82.4 mole percent of polymer), was weighed into a beaker and then 1.45 g of N-allyl-4-methoxy-1,8-naphthalimide (Monomer Example 2, formula weight 267, 0.0054 moles, 0.256 mole percent of polymer) and mixed until the powdered fluorescent monomer dissolved. The fluorescent monomer was 1.16 weight % of the solution containing fluorescent monomer and acrylic acid. Next, 165.6 g of 2-acrylamido-2-methyl propane sulfonic acid sodium salt, 50% solution (0.36 moles, 17.3 mole percent of polymer) was added with mixing until a homogeneous solution was formed. This mixed monomer solution was then fed to the reactor via measured slow-addition with stirring over a period of 3 hours. An initiator solution of 1.45 grams of sodium persulfate was dissolved in 35 grams water was concurrently added, starting at the same time as the monomer solution, for a period of 3.5 hours. The reaction product was then held at 85° C. for 60 minutes. The reactor was then set up for distillation. An azeotropic of 80 g of a mixture of water and isopropyl alcohol was then distilled. 7.6 g of 50% sodium hydroxide dissolved in 115 g of deionized water was dripping during the distillation. The final polymer solution had a solids content of 48% and a pH of 3. The polymer solution was diluted to 10 ppm and the pH adjusted to 9. The fluorescent signal was 13853 at an excitation and emission wavelength of 375 and 460 nm, respectively.

### Example 14: Phosphate Inhibition, Iron Inhibition

The performance of the polymer of Polymer Example 13 was measured for phosphate inhibition and iron inhibition, using the following methods.

Solution “A” was prepared using sodium hydrogen phosphate and sodium tetraborate decahydrate, to create a solution containing 20 mg/L of phosphate, and 98 mg/L of borate and a pH of from 8.0-9.5.

Solution “B” was prepared calcium chloride dihydrate and ferrous ammonium sulfate, to create a solution containing 400 mg/L of calcium and 4 mg/L of iron at a pH of from 3.5-7.0.

The amount of polymer to add to solutions A and B was calculated to provide a 1.00 g/L (1000 mg/L) solids/active solution for testing. The calculations were based upon percent solids per sample in the following manner: % solids/100=X (decimal solids) and (1.000 g/L)/X=g/L polymer to yield a 1000 mg/L polymer solution.

Fifty (50) ml of Solution “B” was dispensed into a 125 ml Erlenmeyer flask using a Brinkman dispensette. Using a graduated piper, the calculated amount of polymer solution was added to give the desired treatment level (i.e., 1 ml of 1000 mg/L polymer solution=10 mg/L in samples). Fifty (50) ml of Solution “A” was dispensed into the 125 ml Erlenmeyer flask using a Brinkman dispensette. Using a Brinkman dispensette, at least three blanks (samples containing no polymer treatment) were prepared by dispensing 50 ml of Solution “B” and 50 ml of Solution “A” to a 125 ml Erlenmeyer flask. The flasks were stoppered and placed in a water bath set at 70° C.+/−5° C. for 16 to 24 hours.

All of the flasks were then removed from the water bath and allowed to cool to the touch. A vacuum apparatus was assembled using a 250 ml side-arm Erlenmeyer flask, vacuum pump, moisture trap, and Gelman filter holder. The samples from the 125 ml Erlenmeyer flask were filtered into the 250 ml side-arm Erlenmeyer flask using 0.2 micron filter paper. The filtrate from the 250 ml side-arm Erlenmeyer flask was transferred into a clean 100 ml specimen cup. The samples were evaluated for phosphate inhibition using a HACH DR/3000

Spectrophotometer following the procedure set forth in the operators manual. The samples were evaluated for iron inhibition using ICP (inductively coupled plasma) to quantify iron.

The % Phosphate inhibition for each treatment level was determined by calculating (S−B)/(T−B)*100, where S=mg/L phosphate in Sample, B=mg/L phosphate in Blank (sample with no treatment) and T=mg/L Total phosphate added.

The % iron inhibition for each treatment level was determined by calculating (Sᵢ−Bᵢ)/Tᵢ−Bᵢ)*100, where Sᵢ=mg/L iron in Sample, Bᵢ=mg/L iron in Blank (sample with no treatment), and Tᵢ=mg/L Total iron added.

TABLE 4
Phosphate inhibition performance of Polymer Example 13

| | % phosphate | |
|---|---|---|
| | inhibition at | % iron inhibition at |
| Polymer | 20 ppm polymer | 20 ppm polymer |
| Example 13 | 95 | 94 |

### Polymer Example 15: Synthesis of Polymer

An initial charge of 190 g of deionized water was added to a 1-liter glass reactor with inlet ports for an agitator, water cooled condenser, thermocouple, and adapters for the addition of monomer and initiator solutions. The reactor contents were heated to 95° C. A monomer solution was prepared by dissolving 1.65 g of N-propyl-4-allyloxy-1,8-naphthalimide (Monomer Example 3) (formula weight 295, 0.00559 moles, 0.127 mole percent of polymer) in 299.2 g of acrylic acid (4.15 moles, 94.6 mole percent of polymer). The fluorescent monomer was 0.55 weight % of the solution containing fluorescent monomer and acrylic acid. This clear monomer solution was added to the reactor over 4 hours. A second solution which consisted of 24.15 g of sodium hypophosphite monohydrate (0.23 moles, 5.27 mole percent of polymer) dissolved in 72 g of deionized water was mixed and then fed to the reactor concurrently over a period of 4 hours. An initiator solution of 6.7 grams of sodium persulfate dissolved in 68.4 grams water was concurrently added, starting at the same time as the monomer and hypophosphite solutions, fora period of 4 hours and 15 minutes. The reaction product was then held at 95° C. for 60 minutes. The final polymer solution had a solids content of about 48.9%. The polymer solution was diluted to 10 ppm and the pH adjusted to 9. The fluorescent signal was 7468 at an excitation and emission wavelength of 377 and 465 nm, respectively.

### Polymer Example 16

An initial charge of 190 g of deionized water was added to a 1-liter glass reactor with inlet ports for an agitator, water cooled condenser, thermocouple, and adapters for the addition of monomer and initiator solutions. The reactor contents were heated to 95° C. A monomer solution was prepared by dissolving 1.82 g of N-propyl-4-allyloxy-1,8-naphthalimide (Monomer Example 4) (formula weight 295, 0.0062 moles, 0.14 mole percent of polymer) in 298.5 g of acrylic acid (4.14 moles, 94.6 mole percent of polymer). The fluorescent monomer was 0.60 weight % of the solution containing fluorescent monomer and acrylic acid. This clear monomer solution was added to the reactor over 4 hours. A second solution which consisted of 24.15 g of sodium hypophosphite monohydrate (0.23 moles, 5.26 mole percent of polymer) dissolved in 72 g of deionized water was mixed and then fed to the reactor concurrently over a period of 4 hours. An initiator solution of 6.79 grams of sodium persulfate dissolved in 68.4 grams water was concurrently added, starting at the same time as the monomer and hypophosphite solutions, fora period of 4 hours and 15 minutes. The reaction was cloudy in the beginning, indicating the insolubility of the N-propyl-4-allyloxy-1,8-naphthalimide in water. However, at about the halfway point of the monomer feed, the reaction became clear. This indicated that the monomer was being incorporated into the water-soluble polymer. The reaction product was then held at 95° C. for 60 minutes. The polymer solution was cooled and then neutralized with and 20.2 g of 50% sodium hydroxide. The final polymer solution had a solids content of about 48.6%. The polymer solution was diluted to 10 ppm and the pH adjusted to 9. The fluorescent signal was 7406 at an excitation and emission wavelength of 379 and 464 nm, respectively.

### Polymer Example 17

An initial charge of 190 g of deionized water was added to a 1-liter glass reactor with inlet ports for an agitator, water cooled condenser, thermocouple, and adapters for the addition of monomer and initiator solutions. The reactor contents were heated to 95° C. A monomer solution was prepared by dissolving 2.38 g of N-allyl-4-(methoxy, triethylene glycol) 1,8-naphthalimide (Monomer Example 5) (formula weight 400, 0.00595 moles, 0.135 mole percent of polymer) in 298.5 g of acrylic acid (4.14 moles, 94.6 mole percent of polymer). The fluorescent monomer was 0.79 weight % of the solution containing fluorescent monomer and acrylic acid. This clear monomer solution was added to the reactor over 4 hours. A second solution which consisted of 24.15 g of sodium hypophosphite monohydrate (0.23 moles, 5.26 mole percent of polymer) dissolved in 72 g of deionized water was mixed and then fed to the reactor concurrently over a period of 4 hours. An initiator solution of 6.79 grams of sodium persulfate dissolved in 68.4 grams water was concurrently added, starting at the same time as the monomer and hypophosphite solutions, for a period of 4 hours and 15 minutes. The reaction product was then held at 95° C. for 60 minutes. The final polymer solution had a solids content of about 48.8%. The polymer solution was diluted to 10 ppm and the pH adjusted to 9. The fluorescent signal was 9109 at an excitation and emission wavelength of 374 and 460 nm, respectively.

### Polymer Example 18: (Comparative)

The procedure of Example 4 in RU2640339 was repeated. An initial charge of 84 g of deionized water and 1 g of ammonium persulfate was placed in a 250 ml glass reactor with inlet ports for an agitator, water cooled condenser, thermocouple. 15 g of acrylic acid (0.208 moles, 99.73 mole percent of polymer) was weighed into a beaker and then 0.15 g of N-allyl-4-methoxy-1,8-naphthalimide (Monomer Example 2, formula weight 267, 0.00056 moles, 0.269 mole percent of polymer) was added to the beaker and mixed until the powdered fluorescent monomer dissolved. This solution was then added to the reactor, with stirring. The reaction mixture was very cloudy, indicating insolubility of the N-allyl-4-methoxy-1,8-naphthalimide in the reaction mixture. The reactor contents were slowly heated to 85° C. When the temperature reached about 80° C., a strong exotherm was observed. The reaction mixture started to thicken and within minutes, a sticky, intractable mass was formed and started to rise up the stir shaft. An attempt was made to remove some of the reaction product from the reactor and try and dissolve it in water. The attempt failed and the material was not soluble in water.

The final intractable product was not water-soluble and could not be used. The final product was intractable because it was extremely viscous and, elastic and sticky and as a result the material could not be pumped out of the reactor. The final product did not have practical utility and could not be used in commercial applications. Simultaneous addition of all the reactants to the reactor before initiation of the reaction has commenced produces an unusable, water insoluble product.

### Polymer Example 19

An initial charge of 152.7 g of deionized water and 152.7 of isopropyl alcohol was added to a 1-liter glass reactor with inlet ports for an agitator, water cooled condenser, thermocouple, and adapters for the addition of monomer and initiator solutions. The reactor contents were heated to 84° C. A mixed monomer solution was prepared in the following manner: 193.4 g of acrylic acid (2.69 moles, 99.72 mole percent of polymer) was weighed into a beaker and then 2.0 g of N-allyl-4-methoxy-1,8-naphthalimide (Monomer Example 2, formula weight 267, 0.00749 moles, 0.278 mole percent of polymer) was added to the beaker and mixed until the powdered fluorescent monomer dissolved. The fluorescent monomer was 2.79 weight % of the solution containing fluorescent monomer and acrylic acid. This mixed monomer solution was then fed to the reactor via measured slow-addition with stirring over a period of 4 hours. An initiator solution of 11.75 grams of sodium persulfate was dissolved in 65 grams water was concurrently added, starting at the same time as the monomer solution, for a period of 4 hours. The reaction product was then held at 85° C. for 60 minutes. The reactor was then set up for distillation. An azeotropic of 254 g of a mixture of water and isopropyl alcohol, was then distilled. 200 g of deionized water was dripped in during the distillation. The final polymer solution had a solids content of 40.5%. The polymer solution was diluted to 10 ppm and the pH adjusted to 9. The fluorescent signal was 17138 at an excitation and emission wavelength of 376 and 459 nm, respectively.

### Polymer Example 20

An initial charge of 190 g of deionized water was added to a 1-liter glass reactor with inlet ports for an agitator, water cooled condenser, thermocouple, and adapters for the addition of monomer and initiator solutions. The reactor contents were heated to 95° C. A monomer solution was prepared by dissolving 1.44 g of N-allyl-4-(methoxy, triethylene glycol) 1,8-naphthalimide (reaction product of Monomer Example 5) (formula weight 400, 0.0036 moles, 0.082 mole percent of polymer) in 298.5 g of acrylic acid (4.14 moles, 94.6 mole percent of polymer). This clear monomer solution was added to the reactor over 4 hours. A second solution which consisted of 24.15 g of sodium hypophosphite monohydrate (0.23 moles, 5.29 mole percent of polymer) dissolved in 72 g of deionized water was mixed and then fed to the reactor concurrently over a period of 4 hours. An initiator solution of 6.69 grams of sodium persulfate dissolved in 69 grams water was concurrently added, starting at the same time as the monomer and hypophosphite solutions, for a period of 4 hours and 15 minutes. The reaction product was then held at 95° C. for 60 minutes. The final polymer solution had a solids content of about 48.35%. The polymer solution was diluted to 10 ppm and the pH adjusted to 9. The fluorescent signal was 4619 at an excitation and emission wavelength of 375 and 461 nm, respectively.

### Polymer Example 21: Synthesis of Polymer

An initial charge of 193 g of deionized water was added to a 1-liter glass reactor with inlet ports for an agitator, water cooled condenser, thermocouple, and adapters for the addition of monomer and initiator solutions. The reactor contents were heated to 95° C. A monomer solution was prepared by dissolving 0.85 g of N-allyl-4-propoxy-1,8-naphthalimide (reaction product of Example 3) (formula weight 295, 0.00288 moles, 0.132 mole percent of polymer) in 187 g of methacrylic acid (2.17 moles, 99.87 mole percent of polymer). The fluorescent monomer was 0.45 weight % of the solution containing fluorescent monomer and methacrylic acid. This clear monomer solution was added to the reactor over 3 hours. A second solution which consisted of 6.94 g of 3-mercapto propionic acid, dissolved in 40.6 g of deionized water was mixed and then fed to the reactor concurrently over a period of 3 hours. An initiator solution of 3.76 grams of sodium persulfate dissolved in 40 grams water was concurrently added, starting at the same time as the 2 other solutions, but over a period of 3.5 hours. The reaction product was then held at 95° C. for 60 minutes. The reaction mixture was cooled and 34.8 g of 50% sodium hydroxide dissolved in 163 g of water was added. The final polymer was a clear solution and had a solids content of about 31%. The polymer solution was diluted to 10 ppm and the pH adjusted to 9. The fluorescent signal was 7654 at an excitation and emission wavelength of 377 and 464 nm, respectively.

### Polymer Example 22: Polymerization Method C

100 grams of xylene and 100 g of maleic anhydride is added to a 1-liter glass reactor with inlet ports for an agitator, water cooled condenser, thermocouple, and adapters for the addition of monomer and initiator solutions. The mixture is heated to reflux. An initiator solution of 10 g of tertiary butyl per-2-ethyl hexanoate and 50 g of xylene is added over 2 hours. 0.25 g N-allyl-4-propoxy-1,8-naphthalimide is added to the reactor at the beginning of the initiator addition, at 30, 60 and 90 minutes. A total of 1 g of fluorescent monomer was added (0.33 mole % of the polymer). The reaction product is heated at reflux for 4 hours and then cooled to 90° C. 50 g of water is then added and the xylene is removed by introducing steam. A clear aqueous solution is obtained at the end of the reaction.

### Example 23: Residual Monomer Content when R₁ in Structure I is Alkoxy

The % conversion of the N-ally-4-methoxy-1,8-naphthalimide in various polymer examples are listed in the table below. Residual unreacted fluorescent monomer in the reaction mixture if measured by LC.

TABLE 5

| | Residual | | | | % Residual |
|---|---|---|---|---|---|
| | unreacted | | | | fluorescent |
| | amount of | Weight of | Amount of | | monomer, |
| | fluorescent | reaction | fluorescent | | based on |
| | monomer | mixture | monomer | | total |
| | at the end | measured at | added to | | monomer |
| | of the | the end of | reaction | | in the |
| Polymer | reaction | the reaction | mixture | % | polymer |
| Example | (ppm) | (grams) | (grams) | Conversion | solution |
| 5 | 140 | 689.9 | 1.32 | 92.7 | 7.3 |
| 8 | 140 | 627 | 2.13 | 95.9 | 4.1 |
| 9 | 90 | 600 | 1.86 | 97.1 | 2.9 |
| 10 | 250 | 703 | 3.19 | 94.5 | 5.5 |
| 11 | <20 | 502.4 | 0.87 | >98.8 | <1.2 |

These data indicate that the conversion percentage of the fluorescent monomer is pretty good. If necessary, the conversion can be improved by monitoring the conversion of the fluorescent monomer during the reaction and adjusting the feed rates of the fluorescent monomer with respect to the other monomers as explained in the specification.

The LC method is as follows:

### Instrument: HPLC

Sample Prep: 80 mg of sample in 1.5 mL of 1:1 25 mM sodium acetate:acetonitrile
Calibration: standard prepared in 25 mM sodium acetate:acetonitrile
Mobile Phase: 40%/60% 25 mM sodium acetate/acetonitrile
Flow Rate: 1 mL/min
Column: Supelcosil LC-18 250 mm×4.6 mm 5 μm
Detector: UV detector monitoring at 370 nm

### Example 24: Calcium Sulfate Scale Inhibition

The performance of the polymer of Example 1, 2, 4 and 7 to inhibit calcium sulfate was measured using the protocol detailed below:

1.0 Objective
To determine the efficacy of polymers in the inhibition of calcium sulfate.

2.0 Equipment:
Large water bath (capable of accommodating fifty 125 ml
Erlenmeyer flasks) set to 50° C.+/−5° C.
Four place Analytical balance, weighing boats, and spatulas
125 ml Erlenmeyer flasks with stoppers
250 ml Erlenmeyer flasks
250 ml side-arm Erlenmeyer flasks
Specimen cups (100 ml)
50 ml graduated cylinder
Pipets: 5 ml serological (graduated in tenths)
Pipets: 2 ml, 5 ml (Class “A” volumetric)
Pipets: disposable transfer
Brinkman dispensette (capable of delivering 50 ml volume)
Pipet bulb
Flasks: 1 L, 2 L (Class “A” volumetric)
Flasks: 3 L volumetric
Buret: 50 ml or 100 ml (Class “A”)
Buret clamp and stand
0.2 or 0.45 micron filter paper
Gelman vacuum filter holder
Vacuum pump with moisture trap
Stainless steel wool, medium grade (optional)
Magnetic stirrer and stirring bars
pH meter

3.0 Reagents:

| | |
|---|---|
| CaCl₂•2H₂O | (reagent grade) |
| Na₂SO₄ anhydrous | (reagent grade) |
| EDTA (disodium salt) | (reagent grade) |
| Ethylene glycol | |
| 1.0N NaOH | (reagent grade) |
| 1.0N HCl | (reagent grade) |
| Murexide indicator | |
| Deionized water | |

4.0 Solution Preparation (Calculations on Last Page):
4.1 Prepare all solutions in deionized water. Prepare volume(s) according to the following table:

| | # OF | VOLUME | |
|---|---|---|---|
| SOLUTION | SAMPLES | REQUIRED | |
| CaCl₂•2H₂O, | 0-18 | 1 | L |
| Na₂SO₄, | 19-36 | 2 | L |
| EDTA | 37-54 | 3 | L |
| Murexide Indicator | 0-54 | 100 | ml |
| Antiscalant | 0-54 | 1 | L |

4.2 SOLUTION “A”: pH 8.4-8.6 (adjust the pH using 1.0N HCl and/or 1.0N NaOH). Using calcium chloride dihydrate, prepare a stock solution of CaCl₂.2H₂O, 24.824 g/L, with an acceptable range of 24.823 g/L-24.825 g/L. Record weight and pH in Laboratory Notebook.
4.3 SOLUTION “B”: pH 8.4-8.6 (adjust the pH using 1.0N HCl and/or 1.0N NaOH). Using anhydrous sodium sulfate, prepare a stock solution of Na₂SO₄, 25.047 g/L, with an acceptable range of 25.046 g/L-25.048 g/L. Record weight and pH in Laboratory Notebook.
4.4 ANTISCALANT PREPARATION:
   4.4.1 Determine total solids or activity for antiscalant(s) to be evaluated.
   4.4.2 Record origin and/or procedure used for determination of total solids and/or activity. Record the total solids and/or activity in Laboratory Notebook.
   4.4.3 Determine the weight of antiscalant necessary to provide a 1.000 g/L (1000 ppm) solids/active solution using the following formula:
      4.4.3.1 (% solids or activity)/100%=“X”

$$“ X ” = decimal solids or decimal activity$$

4.4.3.2 (1.000 g/L)=g/L antiscalant to yield a 1000 ppm antiscalant solution
4.4.4 Record weight in Laboratory Notebook for each antiscalant to be evaluated.
4.5 INDICATOR SOLUTION: Prepare murexide indicator solution, 0.15 g murexide/100 ml ethylene glycol—an acceptable range is 0.15 g/100 ml-0.18 g/100 ml). Record weight in Laboratory Notebook.
4.6 EDTA SOLUTION: Prepare a 0.01M EDTA solution in deionized water, 3.722 g/L (an acceptable range is 3.721 g/L-3.723 g/L; range yields 0.01M concentration). Record weight in Laboratory Notebook.

5.0 Sample Preparation:
5.1 Dispense 50 ml of SOLUTION “A” into a 125 ml Erlenmeyer flask using a Brinkman dispensette. Repeat for all samples. Reserve 50-100 ml of SOLUTION “A” for calculations.
5.2 Using a graduated pipet, add the correct amount of antiscalant polymer solution to give the desired treatment level (i.e. 1 ml of 1000 ppm antiscalant solution=10 ppm in samples). Repeat for all samples.
5.3 Dispense 50 ml of SOLUTION “B” into the flask using Brinkman dispensette. Repeat for all samples.
5.4 Using a Brinkman dispensette, prepare at least three blanks (samples containing no antiscalant treatment) by dispensing 50 ml of SOLUTION “A” and 50 ml of SOLUTION “B” to a 125 ml Erlenmeyer flask. Measure pH of each blank and record in Laboratory Notebook.
5.5 Stopper the flasks and place in the water bath set at 50° C.+/−5° C. for 16-24 hours. After all samples have been placed in the water bath, record “time in” in Laboratory Notebook.

6.0 Sample Evaluation:
6.1 Remove all of the flasks from the water bath and allow them to cool to the touch. After all samples have been removed from the water bath, record “time out” in Laboratory Notebook.
6.2 Assemble the vacuum apparatus using a 250 ml side-arm Erlenmeyer flask, vacuum pump, moisture trap, and Gelman filter holder.
6.3 Filter the samples using 0.2 or 0.45 micron filter paper.
6.4 Transfer the filtrate from the 250 ml side-arm Erlenmeyer flask into an unused 100 ml specimen cup.
6.5 Use a clean 250 ml side-arm Erlenmeyer flask for each sample.
6.6 Titrate the samples using the following method:
   Samples and blanks:
   6.6.1 Into a 250 ml Erlenmeyer flask, pipet 5 ml of filtrate using a 5 ml Class “A” volumetric pipet.
   6.6.2 Using a graduated cylinder, add 50 ml of deionized water to the 250 ml flask.
   6.6.3 Into the flask, pipet 2 ml of 1.0N NaOH using an electronic pipet.
   6.6.4 To the flask, add 5-20 drops of the Murexide indicator solution using a disposable transfer pipet.
   6.6.5 Using a class “A” buret and 0.01M EDTA solution, titrate sample to a purple-violet endpoint. Record ml of 0.01 m EDTA solution necessary to reach this endpoint in Laboratory Notebook.
      Total Calcium
   6.6.6 Using a class “A” volumetric pipet, pipet 10 ml of solution “A” and 10 ml of deionized water into a suitable size beaker. Swirl to mix.
   6.6.7 Using a class “A” volumetric pipet, pipet 5 ml of the solution prepared in step 6.6.6 into a 250 ml Erlenmeyer flask.
   6.6.8 Add 50 ml of deionized water using a graduated cylinder to the flask.
   6.6.9 Pipet 2 ml of 1.0N NaOH into the flask using an electronic pipet.
   6.6.10 Add 5-20 drops of Murexide indicator solution using a disposable transfer pipet to the flask.
   6.6.11 Using a class “A” Buret and 0.01 m EDTA solution, titrate the sample to a purple-violet endpoint. Record ml of 0.01 m EDTA solution necessary to reach this endpoint in the Laboratory Notebook.

7.0 Calculate the Percent Inhibition for all Samples:
7.1 The percent inhibition for each treatment level is determined by using the following calculation:

$$\frac{S - B}{T - B} \times 100 \% = \% INHIBITION$$

S=ml EDTA solution for “sample”
T=ml EDTA solution for “total barium”
B=ml EDTA solution for “blanks”
7.2 Record the determined percent inhibition for each sample in Laboratory Notebook.

8.0 Calculations for Solution Preparation:
8.1 0.01M EDTA solution:

$$EDTA = 372.24 g / mole 372.24 g / mole \times 0.01 M = 3.722 g / L EDTA$$

The polymers from Example 1, 2, 4 and 7 were tested in the test detailed above, for calcium sulfate inhibition.

TABLE 6
Carbonate inhibition

| | % Calcium | % Calcium |
|---|---|---|
| | sulfate | sulfate |
| | inhibition | inhibition |
| | (20 ppm | (50 ppm |
| Polymer | polymer) | polymer) |
| Example 1 | 94 | 99 |
| Example 2 | 92 | 99 |
| Example 4 | 91 | 95 |
| Example 7 | 92 | 94 |

These data indicate that the polymers of this disclosure are excellent for calcium sulfate scale inhibition.

### Polymer Example 25

An initial charge of 190 g of deionized water was added to a 1-liter glass reactor with inlet ports for an agitator, water cooled condenser, thermocouple, and adapters for the addition of monomer and initiator solutions. The reactor contents were heated to 85° C. A monomer solution was prepared by dissolving 2.0 g of N-allyl-4-propoxy-1,8-naphthalimide (0.00678, 0.301 mole % of polymer) in 150 g of acrylic acid (2.08 moles, 94.27 mole % of polymer). This clear monomer solution was added to the reactor over 4 hours. A second monomer solution which consisted of 100 g of methoxy polyethylene glycol 750 methacrylate (0.119 moles, 5.42 mole % of polymer) dissolved in 100 g of deionized water was then fed to the reactor concurrently over a period of 4 hours. An initiator solution of 6.79 grams of sodium persulfate dissolved in 68.4 grams water was concurrently added, starting at the same time as the two monomer solutions, for a period of 4 hours and 15 minutes. The reaction product was then held at 95° C. for 60 minutes. The polymer solution was diluted to 10 ppm and the pH adjusted to 9. The fluorescent signal was 18952 at an excitation and emission wavelength of 376 and 462 nm, respectively.

### Example 26: Silicate Scale Inhibition

The effectiveness of the polymer of example 25 to inhibited silica scale was measured using the protocol below:

Static bottle testing was used to evaluate the efficacy of various polymers to inhibit silica polymerization. Free silica remaining in solution (reactive silica) was tracked using the HACH silicomolybdate colorimetric method. Scale inhibitors with higher efficacy at inhibiting colloidal silica formation maintained higher levels of free silica in solution over time. Stock solutions of each scale inhibitor were made at a concentration of 5000 ppm, based on actives, and the pH of the stock solutions was adjusted to 7.5 with HCl or NaOH. The percent silica inhibition (% I) was calculated according to the following formula:

$$\% I = \{ [ SiO 2 ] p - [ SiO 2 ] b \} * 100 / \{ [ SiO 2 ] i - [ SiO 2 ] b \}$$

Where:

[SiO2]p=free silica concentration in presence of polymeric scale inhibitor at t=21 hours
[SiO2]b=free silica concentration in absence of polymeric scale inhibitor (blank) at t=21 hours
[SiO2]i=initial free silica concentration of silica brine at t=0 hours

The silica inhibition of the polymer of Example 25 was found to be 80% using 150 ppm active polymer.

### Polymer Example 27

A reactor containing 103.84 grams of deionized water and 8.51 grams of Star DRI 42 (Tate and Lyle) was heated to 188° F. 0.20 grams of Maleic anhydride and 3.59 grams of 35% solution of hydrogen peroxide was added to the reactor at 140° F. The reactor was heated to 188° F. A monomer solution containing 28.8 grams of acrylic acid, and 0.1338 grams of the reaction product of Monomer Example 2 was added to the reactor over a period of 2 hours. An initiator solution comprising of 3.8 grams of sodium persulfate in 41.67 grams of deionized DI water was simultaneously added to the reactor over a period of 2 hours and 30 minutes. The reaction product was held at 188° F. for an additional 30 minutes. The reaction mixture cooled down to 160° F. and 2.23 grams of sodium bisulfite was added as a shot to the reactor and then cooked for 15 minutes. A solution of 15.3 grams of sodium hydroxide in 15.3 grams DI water was added to the reactor over 15 mins. The reaction mixture was then mixed for 15 minutes and cooled down to room temperature. 0.50 grams of Proxel GXL was added to the reactor and mixed for 5 additional minutes. The final polymer was a clear amber solution at 39.8% solids and pH of 4.61.

### Polymer Example 28

A reactor containing 70.51 grams of deionized (DI) water and 64.42 grams of isopropyl alcohol was heated to 183° F. 3 grams of solution of 0.1736 grams Ferrous ammonium sulfate in 15 grams deionized water. A monomer solution containing 50.0 grams of acrylic acid, 50.5 grams of styrene, 2.5 grams of methacrylic acid and 0.4041 grams of the monomer product from Monomer Example 2 was added to the reactor over a period of 3 hours and 30 minutes. An initiator solution comprising of 4.6 grams of sodium persulfate in 28.89 grams of DI water was simultaneously added to the reactor over a period of 4 hours. A solution containing 4.0 grams of 3-mercapto propionic acid in 21.25 grams of DI water was also added simultaneously over 3 hours 15 minutes. The reaction product was held at 188° F. for an additional 1 hour. At the end of the cook, 0.06 grams of Silicone S-100 was added to the reactor. The reactor was set up for distillation and 130.0 grams of an azeotropic distillate was distilled off. During the distillation, 62.60 grams of 50% NaOH solution in 95.15 grams of DI water was added. The final product was a viscous yellow solution, which had 35.3% solids.

### Polymer Example 29

A reactor containing 223.96 grams of propylene glycol was heated to 180° F. and sparged with nitrogen. Next, 3.2812 grams of Wako V 501 (from Wako) was added to the reactor followed by 24.02 grams of propylene glycol. Upon addition of V 501, monomer mixture of 84.34 grams of methoxy polyethylene glycol methacrylate 750 and 52.03 grams of DI water was added over 2 hours. Simultaneously, a second monomer mixture of 47.2 grams of methyl methacrylate, 0.2322 grams of the monomer product from Monomer Example 2, 8.7 grams of methacrylic acid and 1.1 grams of 3-mercaptopropionic acid was also added to the reactor over 2 hours. The reaction product was held at 180° F. for an additional hour. The final polymer was a opaque amber solution at 31.0% solids and pH of 8.58.

### Polymer Example 30

A reactor containing 98.96 grams of DI water and 174.90 grams of diallyldimethylammonium chloride (65% solution in water) was heated to 155° F., while being sparged with nitrogen. A monomer mixture of 32.30 grams of acrylic acid, 0.48 grams of the monomer product of Monomer Example 2 and 36.90 grams of hydroxypropyl acrylate was prepared. An initiator solution of 0.78 grams of ammonium persulfate in 32.43 grams of DI water was also prepared. When the reactor had reached 155° F., 0.26 grams of Versene 100 was added to the reactor. Next, 7 ml of the monomer solution was added as a shot and mixed for 5 minutes. 7 ml of the initiator solution was added as a shot at the end of 5 minutes. The reactor temperature was maintained below 170° F. When the temperature was stable at 155° F., the monomer and initiator solutions were added separately but over 3 hours simultaneously. At the end of the feeds, the reaction mixture was held at 170 F for 2 hours. At the end of the 2 hours, reactor was held at 185 F for 1 hour. The solution was cooled down to room temperature. A solution of 12.24 grams of sodium hydroxide and 271.10 grams of DI water and mixed for 15 minutes. The final polymer was an opaque yellow solution at 28.8% solids and pH of 3.15.

### Example 31

The polymer samples from the indicated Examples were diluted in water to 10 ppm. The fluorescent signal was determined by excitation of the sample at the excitation wavelengths and measurement at the emission wavelengths as stated in Table 7.

TABLE 7
Fluorescence data for Polymer Examples

| Polymer | Emission | Excitation | |
|---|---|---|---|
| Example | wavelength | wavelength | Fluorescence |
| number | (nm) | (nm) | Intensity |
| 27 | 457 | 375 | 2244 |
| 28 | 460 | 375 | 7788 |
| 29 | 457 | 375 | 4112 |
| 30 | 457 | 375 | 3609 |

### Polymer Example 32

1,8-naphthalilmide [Structure (III)] will be an impurity in the monomer of Example 1 namely N-allyl-naphthalimide [Structure (I)], if ammonia is present as in impurity in the allylamine used to synthesize N-allyl-naphthalimide

The fluorescent signal for 1,8-naphthalilmide, and the polymers of Polymer Example 1 and Polymer Example 2 were measured at 10 ppm polymer and 59 ppb of 1,8-naphthalilmide. 10 ppm of these polymers will contain approximately 59 ppb of the N-allyl-naphthalimide monomer. A solution of 1000 ppm of 1,8-naphthalilmide (obtained from Aldrich) in acetic acid was first prepared by stirring. This was then diluted to 59 ppb by addition of the ionized water. The pH of the solution was 3.9. The polymer solutions were diluted to 10 ppm of active polymer and the pH adjusted to 3.9.

TABLE 7
Fluorescence data

| | | Excitation | Emission | |
|---|---|---|---|---|
| | | wavelength | wavelength | Fluorescence |
| Sample | Description | λ (nm) | λ (nm) | intensity |
| | 1,8-naphthalilmide | 343 | 393 | 25530 |
| Polymer | AA/phosphino/ | 343 | 393 | 10310 |
| Example 1 | N-allyl-naphthalimide = | | | |
| | 94.5/5.28/0.25 | | | |
| Polymer | AA/phosphino/ | 343 | 393 | 10809 |
| Example 2 | N-allyl-naphthalimide = | | | |
| | 94.23/5.27/0.5 | | | |

These fluorescence data indicate that the maximum wavelengths for absorption and emission were approximately the same, namely 343 and 393 nm respectively. More importantly, the 1,8-naphthalilmide impurity of Structure III has a signal that is stronger than that of the polymers of Example 1 and 2 containing the Monomer Example 1 N-allyl-naphthalimide (Structure I). This impurity cannot be polymerized and therefore will give a false signal which gives an error in the measurement of the polymer. This error is multiplied as the cycles of concentration increases. Therefore, the impurity 1,8-naphthalilmide (Structure III) needs to be minimized or preferably eliminated. Therefore, the monomers of Structure I need to have less than 10 mole percent or less of the impurities of Structure III or more preferably need to be substantially free of the impurities of Structure III. The impurity of Structure III can be minimized by using pure allylamine that is free of ammonia and alkyl amines. Preferably, the allylamine needs to have less than 5 weight percent, less than 2 weight percent, less than 1 weight percent, and less than 0.5 weight percent of ammonia and alkyl amines.

The sample of Allyl Amine (Sigma-Aldrich, 98% purity) used in our monomer synthesis was analyzed by neat split injection GC/MS. Peaks are reported in Table 1 by area percent.

TABLE 8
Results of Analysis by neat
split injection GC/MS

| Peak I.D. | Area % |
|---|---|
| Ammonia | 1.0006 |
| Water | 0.083 |
| Hydrazine | 0.025 |
| Allyl Amine | 93.173 |
| Hexadiene | 0.6 |
| Allyl Ether | 0.145 |
| Di-Allyl Amine | 4.413 |
| n-propyl | 0.267 |
| azetidine | |
| Tri-allyl Amine | 0.062 |

GC/MS Procedure

1 ul of sample was analyzed by neat split injection GC/MS

| | |
|---|---|
| Column | 30M × 0.32 mm 0.5 um DB-5 |
| Temp Prog | 40 C. hold 2 min 12 C./min to 200 C. |

The amount of ammonia was relatively low compared to the allylamine which helps minimization of Structure (III).

### Polymer Example 33

The viscosity of the final polymer solutions of a number of examples were measured at 25° C. at 10 rpm.

TABLE 9
Viscosity data for Polymer Examples

| | Composition | Viscosity |
|---|---|---|
| | (with mole percent of each | cps at |
| Polymer | component) | 10 rpm |
| Example 1 | AA/phosphino/N-allyl- | 480 |
| | naphthalimide = | |
| | 94.5/5.28/0.25 | |
| Example 2 | AA/phosphino/N-allyl- | 410 |
| | naphthalimide = | |
| | 94.23/5.27/0.5 | |
| Example 4 | AA/MMA/methoxy allyl | 110 |
| | naphthalimide = | |
| | 93.22/6.5/0.275 | |
| Example 7 | Maleic | 370 |
| | acid/AA/MMA/AMPS/ | |
| | methoxy allyl | |
| | naphthalimide = | |
| | 24.95/64.4/4.5/6.0/0.14 | |
| Example 9 | AA/AMPS/methoxy | 50 |
| | allyl naphthalimide = | |
| | 93.2/6.5/0.25 | |
| Example 10 | AA/methoxy allyl | 470 |
| | naphthalimide/ | |
| | phosphino = | |
| | 94.4/.27/5.3 | |
| Example 11 | Maleic acid/ methoxy | 10 |
| | allyl naphthalimide = | |
| | 99.86/0.14 | |
| Example 13 | AA/methoxy allyl | 340 |
| | naphthalimide/AMPS = | |
| | 82.4/.26/17.3 | |
| Example 15 | AA/N-propyl-4-allyloxy- | 2260 |
| | 1,8- | |
| | naphthalimide/phosphino = | |
| | 94.6/.13/5.27 | |
| Example 19 | AA/methoxy allyl | 80 |
| | naphthalimide = | |
| | 99.72/.28 | |
| Example 20 | AA/N-allyl-4-(methoxy, | 210 |
| | triethylene glycol) 1,8- | |
| | naphthalimide/phosphino | |
| | 94.6/.082/5.29 | |
| Example 24 | AA/N-allyl-4-propoxy- | 710 |
| | 1,8-naphthalimide/ | |
| | methoxy polyethylene | |
| | glycol 750 methacrylate | |
| | 94.3/.30/5.42 | |

These data indicate that the viscosity of these polymer solutions are low and these polymer solutions are easily pumpable.

1. A water-soluble fluorescent polymer useful in water treatment and obtainable by polymerizing a polymerization mixture comprising:
(a) at least one carboxylic acid monomer present in an amount of 10-99.999 mol % based on 100 mol % of the polymer; and
(b) at least one non-quaternized fluorescent naphthalimide derivative monomer selected from Structure (I) and Structure (II): 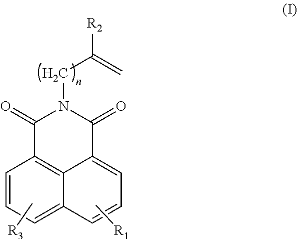
wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂Ol —)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably H or C₁-C₂alkyl, more preferably H or C₁alkyl,
n=0-10, and is preferably 1, and
m=1-10;
and 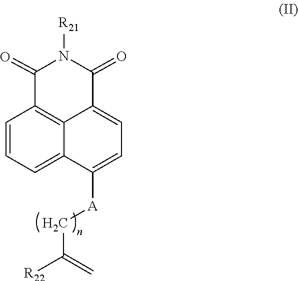
wherein A is selected from —(NR₂₃)—, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-, and
R₂₂ and R₂₄ are independently H or C₁-C₄alkyl, preferably H or C₁-C₂alkyl, more preferably H or C₁alkyl,
said at least one non-quaternized fluorescent monomer being present in the water-soluble fluorescent polymer in an amount of 0.001-20 mol %.

2. The polymer according to claim 1, wherein said at least one non-quaternized fluorescent naphthalimide derivative monomer comprises either (a) Structure (I) comprising less than 15 mol %, based on 100 mol % of Structure (I), of Structure (III) or (b) Structure (II) comprising less than 15 mol %, based on 100 mol % of Structure (II), of Structure (IV), wherein:
Structure (I) is: 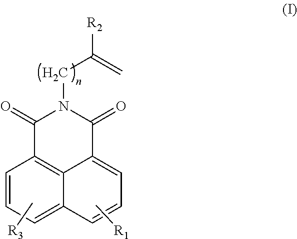
wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably H or C₁-C₂alkyl, more preferably H or C₁alkyl,
n=0-10, and is preferably 1, and
m=1-10;
Structure (II) is: 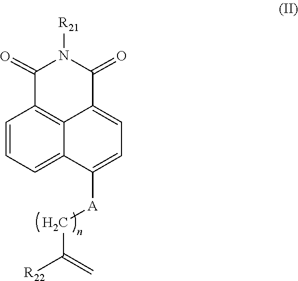
wherein A is selected from —(NR₂₃)—, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-, and
R₂₂ and R₂₄ are independently H or C₁-C₄alkyl, preferably H or C₁-C₂alkyl, more preferably H or C₁alkyl;
Structure (III) is: 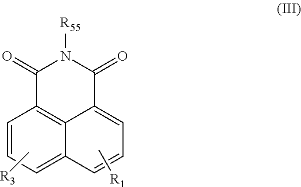
where R₅₅ is H or alkyl; and
Structure (IV) is: 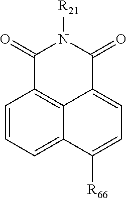
where R₆₆ is H or alkyl.

3. The polymer according to either one of claim 1 or 2, wherein R₁ and R₃ are independently H or alkoxy.

4. The polymer according to any one of claims 1-3, wherein the polymerization mixture additionally contains at least one comonomer selected from the group consisting of:
(a) phosphorus moiety containing monomers;
(b) sulfonic acid containing monomers; and/or
(c) non-ionic monomers.

5. The polymer according to any one of claims 1-4, which comprises the at least one non-quaternized fluorescent naphthalimide derivative monomer incorporated into the polymer to an extent equal to or greater than 85%.

6. The polymer according to any one of claims 1-5, which is pumpable.

7. A fluorescent monomer composition, suitable as a premix for preparing the polymer according to any one of claims 1-6, comprising:
(a) one or more fluorescent monomers selected from Structure (I) and Structure (II): 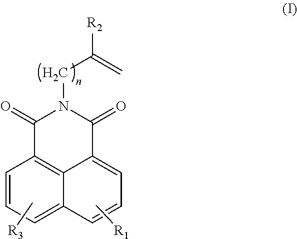
wherein R₁ and R₃ are independently selected from H, hydroxy, alkoxy, aryloxy, arylalkoxy, alkylaryloxy, amino, alkylamino, arylamino, arylalkylamino, alkylarylamino, pyrrolyl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or methyl,
n=0-10, and is preferably 1, and
m=1-10;
and 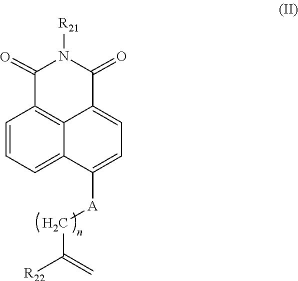
wherein A is selected from —(NR23)-, or —O—, and —O-alk-aryl-,
R₂₃ is H or alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, (—OCH₂CHR₂₄), —O—C₁-C₄alk, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-,
R₂₂ and R₂₄ are independently H or C₁-C₆ alkyl, and
(b) a solvent comprising acrylic acid, methacrylic acid, or a mixture thereof,
wherein said composition comprises at least 2 weight % of said one or more fluorescent monomers.

8. A fluorescent monomer suitable for use in preparing the polymer of any one of claims 1-6, said monomer comprising either (a) Structure (I) comprising less than 15 mol %, based on 100 mol % of Structure (I), of Structure (III) or (b) Structure (II) comprising less than 15 mol %, based on 100 mol % of Structure (II), of Structure (IV), wherein:
Structure (I) is: 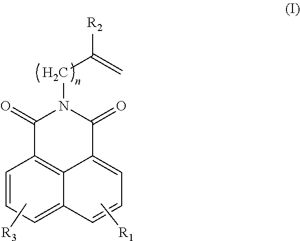
wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably H or C₁-C₂alkyl, more preferably H or C₁alkyl,
n=0-10, and is preferably 1, and
m=1-10;
Structure (II) is: 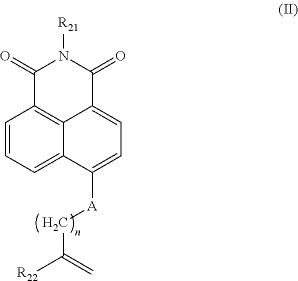
wherein A is selected from —(NR₂₃)—, —O—, and —O-alk-aryl-,
R₂₃ is selected from H and C₁-C₄alkyl,
R₂₁ is selected from H, alkyl, aryl, alkaryl, hydroxy, alkoxy, aryloxy, arylalkoxy, alkylaryloxy, alkoxy amine, amino, N,N-dialkylaminoalkyl, halogen, C₁-C₄alk-O—(CHR₂₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
m=1-10,
n=0-10, and is preferably 1 when A is —O—, and preferably 0 when A is —O-alk-aryl-, and
R₂₂ and R₂₄ are independently H or C₁-C₄alkyl, preferably H or C₁-C₂alkyl, more preferably H or C₁alkyl;
Structure (III) is: 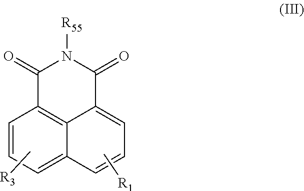
where R₅₅ is H or alkyl; and
Structure (IV) is: 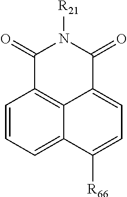
where R₆₆ is H or alkyl.

9. A non-quaternized fluorescent naphthalimide derivative monomer suitable for use in preparing the polymer of any one of claims 1-6, said monomer being selected from Structure (I): 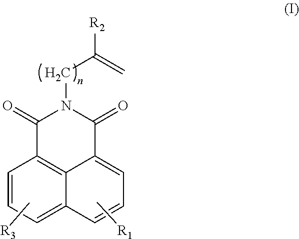
wherein R₁ and R₃ are independently selected from H, hydroxy, alkoxy, aryloxy, arylalkoxy, alkylaryloxy, amino, alkylamino, arylamino, arylalkylamino, alkylarylamino, heteroaryl, halogen, —NO₂, C₁-C₄alk-O—(CHR₄CH₂O—)ₘ, —CO₂H or a salt thereof, —SO₃H or a salt thereof, —PO₃H₂ or a salt thereof, -alkylene-CO₂H or a salt thereof, -alkylene-SO₃H or a salt thereof, and -alkylene-PO₃H₂ or a salt thereof,
R₂ and R₄ are independently H or C₁-C₄alkyl, preferably H or C₁-C₂alkyl, more preferably H or C₁alkyl,
n=0-10, and is preferably 1, and
m=1-10; with the proviso that R₁ and R₃ are not both H.

10. The monomer of claim 9, wherein R₁ and R₃ are both alkoxy or preferably methoxy.

11. The monomer of either one of claim 9 or 10, which is a mixture of two monomers of Structure (I), a first wherein R₁ is alkoxy and R₃ is H and a second wherein R₁ and R₃ are both alkoxy.

12. A water-soluble polymer prepared by polymerizing the fluorescent monomer of any one of claims 7-11 with other monomers.

13. The polymer according to claim 12, wherein the other monomers are selected from the group consisting of cationic, anionic, and/or nonionic monomers.

14. The polymer according to claim 13, wherein the fluorescent monomer is incorporated into polymer to an extent equal to or greater than 85%.

15. An aqueous solution comprising at least one water-soluble fluorescent polymer according to any one of claim 1-6 or 12-14; which preferably comprises at least 10 wt %, based on a total weight of said solution, of said at least one water-soluble fluorescent polymer.

16. The aqueous solution according to claim 15, which comprises at least 20 wt %, based on a total weight of said solution, of said at least one water-soluble fluorescent polymer.

17. A method of inhibiting scale in an industrial water system, the method comprising:
(a) introducing the water-soluble polymer of any one of claim 1-6 or 12-14 into an industrial water system; and
(b) monitoring a fluorescent signal emitted from the water-soluble fluorescent polymer.

18. The method according to claim 17, wherein the scale is selected from phosphate scale, carbonate scale, silica scale, and sulfate scale.

19. Use of the water-soluble polymer of any one of claim 1-6 or 12-14 as an additive to prevent coagulation or to prevent flocculation.

20. A method for coagulation or flocculation in a water treatment system, the method comprising the steps of:
(a) dosing the water system with the water-soluble polymer of any one of claim 1-6 or 12-14; and
(b) monitoring the fluorescent signal emitted from the water treatment system.

21. A method for determining whether a given location has been cleaned comprising the steps of:
(a) applying the water-soluble polymer of any one of claim 1-6 or 12-14 to the location;
(b) cleaning the location at least once; and
(c) attempting to detect the presence of the fluorescent naphthalimide derivative remaining at the location after said cleaning, which, presence, if detected, indicates that additional cleaning is needed.
